(19) United States
(12) Patent Application Publication
(10) Pub. No.: US 2015/0047001 A1
(43) Pub. Date: Feb. 12, 2015

(54) APPLICATION PROGRAM EXECUTION DEVICE

(71) Applicants: Yukio Izumi, Chiyoda-ku (JP); Shoji Sakurai, Chiyoda-ku (JP); Nobuhiro Kobayashi, Chiyoda-ku (JP); Yoichi Shibata, Chiyoda-ku (JP); Manabu Misawa, Chiyoda-ku (JP)

(72) Inventors: Yukio Izumi, Chiyoda-ku (JP); Shoji Sakurai, Chiyoda-ku (JP); Nobuhiro Kobayashi, Chiyoda-ku (JP); Yoichi Shibata, Chiyoda-ku (JP); Manabu Misawa, Chiyoda-ku (JP)

(73) Assignee: Mitsubishi Electric Corporation, Chiyoda-ku, Tokyo (JP)

(21) Appl. No.: 14/385,952

(22) PCT Filed: Mar. 7, 2013
(86) PCT No.: PCT/JP2013/056338

§ 371 Date: Sep. 17, 2014

(30) Foreign Application Priority Data
May 10, 2012 (JP) PCT/JP2012/061979

(51) Int. Cl. H04L 29/06; H04L 9/08

(52) U.S. Cl. CPC H04L 63/08; H04L 9/0816; H04L 2209/24
USPC 726/7

(57) ABSTRACT

When a first communication part of an application program management part receives, from an application, an access request requesting use of a protected resource, an authentication information acquisition part acquires authentication information employed for verification of a legitimacy of the application program management part, from an authentication information storage part. A second communication part transmits the access request from the application and the authentication information, to an authentication part that determines whether or not the application is permitted to use the protected resource.

### TECHNICAL FIELD

The present invention relates to a technique that authenticates an application program (to be merely referred to as an “application” as well hereinafter).

### BACKGROUND ART

In recent years, in an equipment such as a mobile telephone, a mobile terminal, and a television, a system is implemented in which a downloaded application is executed in order to provide various types of services to the user.

The user can download these applications from an application distribution server via a network and install the applications in an equipment such as a mobile telephone.

Also, the user installs the applications in an equipment such as a mobile telephone from another equipment, a PC (Personal Computer), or the like using an exchangeable storage medium such as a memory card (registered trademark).

These applications may possibly include a fraudulent application.

The fraudulent application may fraudulently access confidential information in the equipment, such as personal information, or fraudulently use a function that is not authorized for the user to use.

Therefore, a security countermeasure is needed that authorizes only a specific application to access specific confidential information or a function of the equipment (these will be referred to as “resource” hereinafter).

Examples of such a security countermeasure include, for example, the technique described in Patent Literature 1.

In Patent Literature 1, secret authentication information for authenticating the application as being legitimate and a secret authentication key which generates the authentication information are incorporated in an application.

In an equipment in which this application is installed, an authentication module provided in the equipment receives authentication information from the application before the application accesses resources in the equipment, and authenticates the application as being legitimate, using the received authentication information.

If the authentication is successful, the authentication module permits the application to access the resources.

### CITATION LIST

### Patent Literature

Patent Literature 1: JP 2005-49991

### SUMMARY OF INVENTION

### Technical Problem

In the technique of Patent Literature 1, authentication information which the authentication module uses for authentication is incorporated in the application.

Hence, if a malicious user analyzes the application, the authentication information within the application might be exposed, and the resources in an equipment might be accessed fraudulently.

The present invention has been made in view of the above situations, and has as its major object to realize a mechanism that can authenticate an application program as being legitimate without a need for incorporating authentication information into the application program that can be downloaded by anybody.

### Solution to Problem

An application program execution device according to the present invention is an application program execution device in which an application program is implemented and which includes an application program management part that manages use of a resource by the application program,

the application program management part having

a first communication part for communicating with the application program,

an authentication information acquisition part which acquires authentication information with which the application program management part is proven to be legitimate through a predetermined authentication process, independently of the application program, and

a second communication part which transmits the authentication information acquired by the authentication information acquisition part to an authentication part which determines whether or not the application program is permitted to use the resource.

### Advantageous Effects of Invention

According to the present invention, an authentication information acquisition part acquires authentication information independently of an application program and transmits the authentication information to an authentication part. Therefore, the application program can be authenticated as being legitimate without a need for incorporating the authentication information into the application program.

### BRIEF DESCRIPTION OF DRAWINGS

FIG. 1 shows a configuration example of an application program execution device according to Embodiment 1.

FIG. 2 is a flowchart showing a process flow according to Embodiment 1.

FIG. 3 shows a configuration example of an application program execution device according to Embodiment 2.

FIG. 4 is a flowchart showing a process flow according to Embodiment 2.

FIG. 5 is a flowchart showing the process flow according to Embodiment 2.

FIG. 6 shows a configuration example of an application program execution device according to Embodiment 3.

FIG. 7 is a function conceptual diagram of the application program execution device according to Embodiment 3.

FIG. 8 is a flowchart showing a process flow according to Embodiment 3.

FIG. 9 is a flowchart showing the process flow according to Embodiment 3.

FIG. 10 shows a configuration example of an application program execution device according to Embodiment 4.

FIG. 11 shows a hardware configuration example of an application program execution device according to Embodiments 1 to 4.

FIG. 12 shows a configuration example of an application program execution device according to Embodiment 5.

FIG. 13 is a flowchart showing a process flow according to Embodiment 5.

FIG. 14 is a flowchart showing the process flow according to Embodiment 5.

FIG. 15 shows a configuration example of an application program execution device according to Embodiment 6.

FIG. 16 is a flowchart showing a process flow according to Embodiment 6.

FIG. 17 is a flowchart showing the process flow according to Embodiment 6.

FIG. 18 shows a configuration example of an application program execution device according to Embodiment 7.

FIG. 19 is a flowchart showing a process flow according to Embodiment 7.

FIG. 20 shows a configuration example of an application program execution device according to Embodiment 8.

FIG. 21 is a flowchart showing a process flow according to Embodiment 8.

FIG. 22 shows a configuration example of an application program execution device according to Embodiment 9.

### DESCRIPTION OF EMBODIMENTS

### Embodiment 1

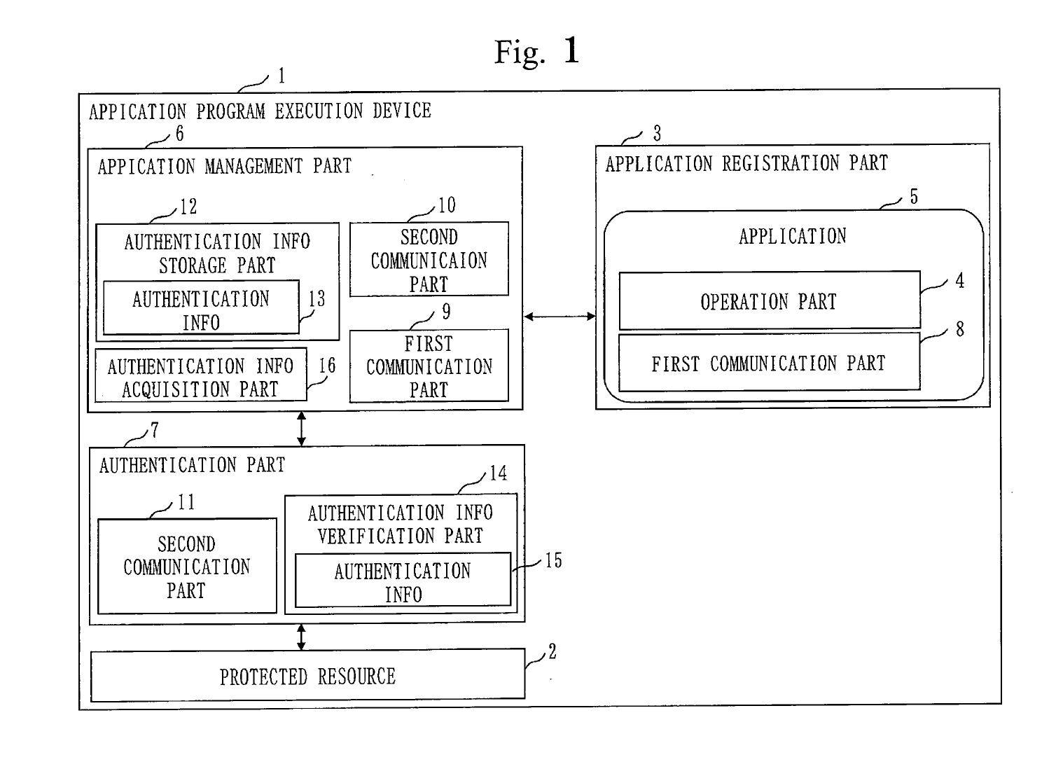

FIG. 1 shows a configuration example of an application program execution device according to this embodiment.

Referring to FIG. 1, an application program execution device 1 is an equipment, for example, such as a mobile telephone, a mobile terminal, and a television in which an application is installed.

A protected resource 2 is a resource to be protected, and is, for example, secret information, a specific program, a specific file, or a specific function.

An application registration part 3 holds an application 5 which is installed from outside of the application program execution device 1.

The application 5 includes an operation part 4 as a user interface, and a first communication part 8 to communicate with an application program management part 6. The application 5 does not include authentication information.

The application 5 transmits an access request (resource use request) requesting use of the protected resource 2, from the first communication part 8.

Upon reception of the access request from the application 5, the application program management part 6 (to be expressed as “application management part 6” hereinafter) transmits the access request to an authentication part 7, and transmits authentication information for proving the transmission source of the access request as being the legitimate application management part 6, to the authentication part 7.

In the application management part 6, a first communication part 9 receives the access request from the first communication part 8 in the application 5.

An authentication information storage part 12 stores authentication information 13.

The authentication information 13 is information with which the application management part 6 as the transmission source of the access request is proven to be legitimate, through the authentication process of the authentication part 7.

The authentication information 13 is, for example, the same information as authentication information 15 stored in an authentication information verification part 14 to be described later.

In this manner, the authentication information storage part 12 shares the authentication information with the authentication information verification part 14.

The authentication information 13 is kept confidential only to the authentication part 7.

When the first communication part 9 receives the access request, an authentication information acquisition part 16 acquires the authentication information 13 from the authentication information storage part 12 independently of the application 5.

A second communication part 10 transmits the access request received by the first communication part 9 and the authentication information 13 acquired by the authentication information acquisition part 16 to a second communication part 11 of the authentication part 7.

The authentication part 7 authenticates the application management part 6 and accesses the protected resource 2.

In the authentication part 7, the second communication part 11 receives the access request and the authentication information 13 from the second communication part 10 of the application management part 6.

The authentication information verification part 14 stores the authentication information 15, and verifies, using the authentication information 15, the authentication information 13 received by the second communication part 11.

The application program execution device 1 is provided with a ROM (Read Only Memory), a RAM (Random Access Memory), a CPU (Central Processing Unit), and the like. The elements of the application management part 6 and authentication part 7 can be implemented by software.

Part of the application management part 6 and authentication part 7 may be implemented by firmware, or hardware.

The hardware configuration of the application program execution device 1, and the relation among the hardware, software, and firmware will be described later.

The operation will be described.

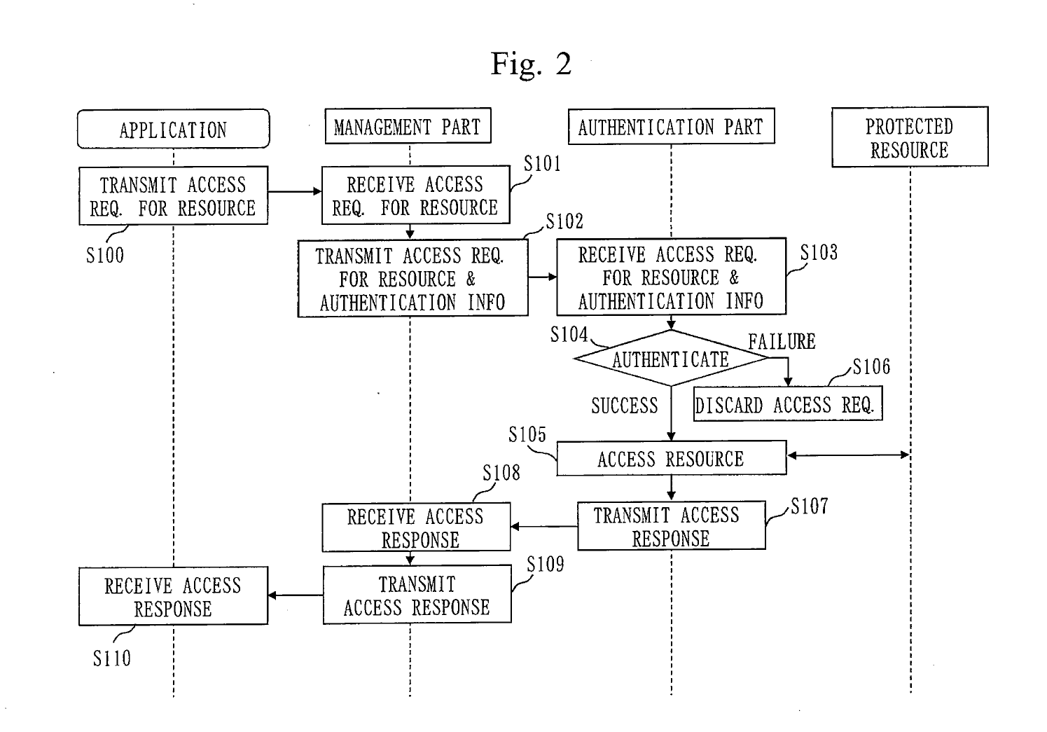

FIG. 2 is a process flow of the application program execution device 1 according to this embodiment.

In FIG. 2, the application management part 6 is expressed as “management part”.

When the application 5 in the application registration part 3 is actuated and is to access the protected resource 2, the first communication part 8 transmits the access request requesting use of the protected resource 2, to the application management part 6 (S100).

The access to the protected resource 2 is an access such as information writing and reading, or an access to the function of the application program execution device 1 such as a communication function with the outside.

The latter includes various types of accesses such as information writing and reading, transmission of information and instruction, and reading of an instruction execution result via the function. Hence, depending on the process, information or a process instruction to be written, and the like may be included in the access request to the protected resource 2.

In the application management part 6, the first communication part 9 receives the access request for the protected resource 2 from the application 5 (S101).

The authentication information acquisition part 16 acquires the authentication information 13 from the authentication information storage part 12, and the second communication part 10 transmits the authentication information 13 and the access request for the protected resource 2 to the authentication part 7 (S102).

Assume that the legitimacy of the application 5 is ensured by verification in installing the application 5.

In the authentication part 7, the second communication part 11 receives the access request for the protected resource 2 and the authentication information 13 from the application management part 6 (S103).

The authentication information verification part 14 verifies the authentication information 13 using the authentication information 15, thereby authenticating whether the access request has been transmitted from a legitimate transmission source (that is, application management part 6) (S104).

The authentication information 13 may be verified by any method.

As the result of the authentication in S104, if the authentication is successful, the authentication information verification part 14 accesses the requested resource (S105).

If the authentication fails, the access request is discarded (S106).

At this time, the authentication information verification part 14 may respond to the application management part 6 that the authentication failed.

After that, the authentication part 7 transmits an access response to the application management part 6 via the second communication part 11 (S107).

If the access request is information reading or the like, readout information may be included in this response.

In the application management part 6, the second communication part 10 receives the access response from the authentication part 7 (S108), and the first communication part 9 transmits the access response to the application 5 (S109).

In the application 5, the first communication part 8 receives the access response from the application management part 6 (S110).

A flow is explained above where after the application management part 6 receives the access request for the resource from the application 5, the authentication part 7 conducts authentication using the authentication information 13 and the authentication information 15.

Alternatively, when the power supply of the application program execution device 1 is turned on, the authentication part 7 may conduct authentication using the authentication information 13 and the authentication information 15, and afterwards may not conduct an authentication process when an access request is issued.

Alternatively, if the access request is issued within a predetermined period of time since the application program execution device is turned on, the authentication part 7 may not conduct an authentication process.

Also, the authentication part 7 may be provided outside the application program execution device 1, as with an IC card. The application management part 6 in the application program execution device 1 may access a resource in or outside the application program execution device 1 via the external authentication part 7.

Where a plurality of resources exist, identification information for the resource to be accessed may be included in the access request. The authentication part may access the resource that matches the identification information.

As described above, the application accesses the resource via the application management part and the authentication part. Hence, authentication information that should be kept secret need not be incorporated in the application, so that a secure system can be provided to the user.

An application developer does not need to conduct the security management of the authentication information, and authentication for a plurality of applications can be performed by a single application management part. Thus, the application development cost can decrease, so that the service can be provided to the user at a low cost.

### Embodiment 2

In Embodiment 1, the application 5 accesses the authentication part 7 via the application management part 6. An embodiment will be described in which the downloaded application 5 accesses the authentication part 7 via a preinstalled application.

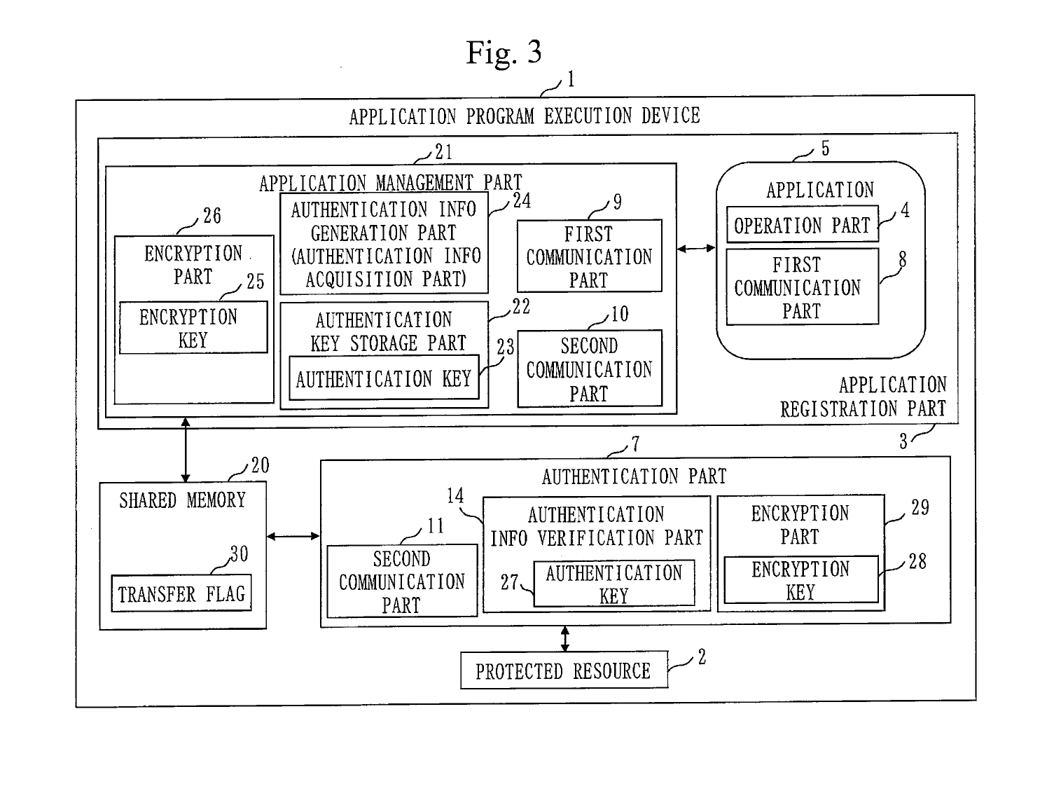

FIG. 3 shows a configuration example of the application program execution device 1 according to this embodiment.

The application program execution device 1 in this embodiment is roughly grouped into the protected resource 2, the application registration part 3, the authentication part 7, and a shared memory 20.

In this embodiment, the application registration part 3 incorporates an application management part 21 (to be referred to as “application management part 21” hereinafter).

The application management part 21 is an application that has been installed in the application program execution device 1 in advance by the manufacturer of the application program execution device 1.

The application management part 21 has no user interface, and the data is not copied or moved to an external storage device such as an SD (registered trademark) card connected to the application program execution device 1.

The application 5 is an application that was downloaded later on, as with Embodiment 1.

The internal configuration of the application 5 is the same as that in Embodiment 1, and its description will accordingly be omitted.

In the application management part 21, an authentication key storage part 22 stores an authentication key 23.

The authentication key 23 is a key of a common key algorithm or a public key/secret key of a public key algorithm, which are oriented to an authentication method such as a challenge/response method or keyed message authentication code.

If the common key algorithm is employed, the authentication key 23 stored in the authentication key storage part 22 is the same as the authentication key 27 stored by the authentication information verification part 14 of the authentication part 7.

If the public key algorithm is employed, the authentication key 23 stored in the authentication key storage part 22 is a key that matches an authentication key 27 stored in the authentication information verification part 14 of the authentication part 7.

In this manner, the authentication key storage part 22 and the authentication information verification part 14 of the authentication part 7 share the authentication key.

An authentication information generation part 24 generates authentication information using the authentication key 23 of the authentication key storage part 22.

The authentication information is employed for verifying the legitimacy of the application management part 21, as with Embodiment 1.

In this embodiment, the authentication information generation part 24 is an example of an authentication information acquisition part.

An encryption part 26 holds an encryption key 25, and encrypts the authentication information using the encryption key 25.

The first communication part 9 receives an access request from the first communication part 8 in the application 5, as with Embodiment 1.

The communication between the first communication part 8 and the first communication part 9 can be an inter-process communication or the like.

The second communication part 10 writes in the shared memory 20 the authentication information encrypted by the encryption part 26.

The authentication part 7 is constituted by the authentication information verification part 14 which verifies the received authentication information using the authentication key 27, an encryption part 29 which conducts encryption and decryption using an encryption key 28, and the second communication part 11 which accesses the shared memory 20.

The shared memory 20 is a storage device such as a RAM. The application management part 21 and the authentication part 7 can write and read information in and from the shared memory 20.

The shared memory 20 is provided with a transfer flag 30 that indicates which one of the application management part 21 and the authentication part 7 is writing information.

In this embodiment, when the transfer flag 30 is cleared, the application management part 21 can write in the shared memory 20; when the transfer flag 30 is set, the authentication part 7 can write in the shared memory 20.

The operation will now be described.

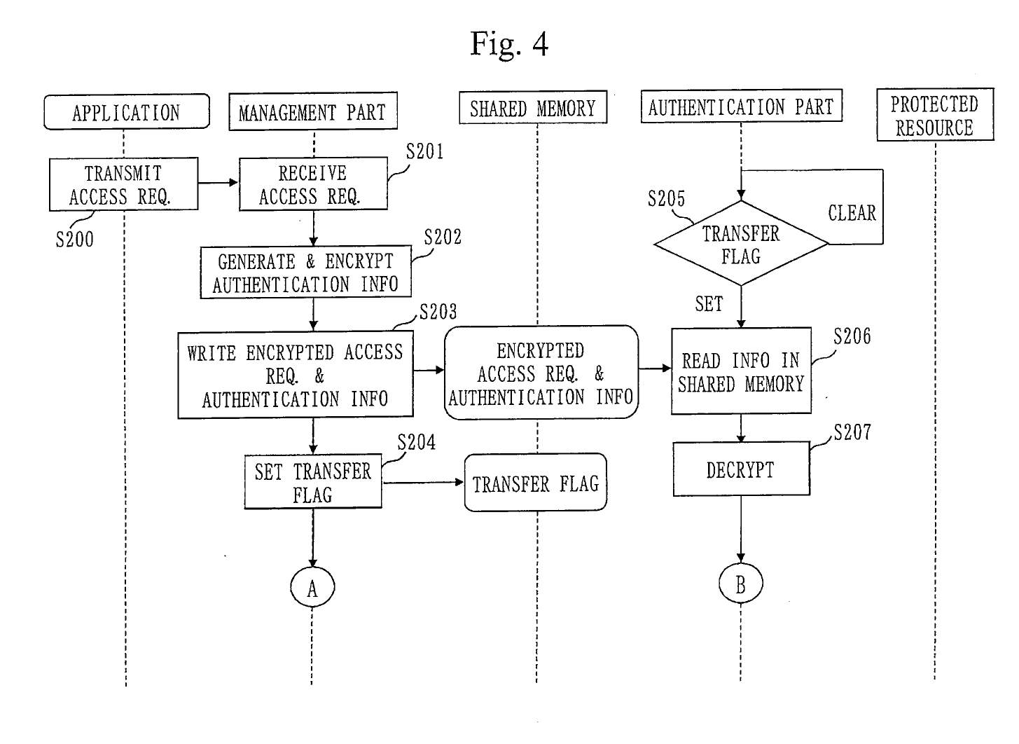

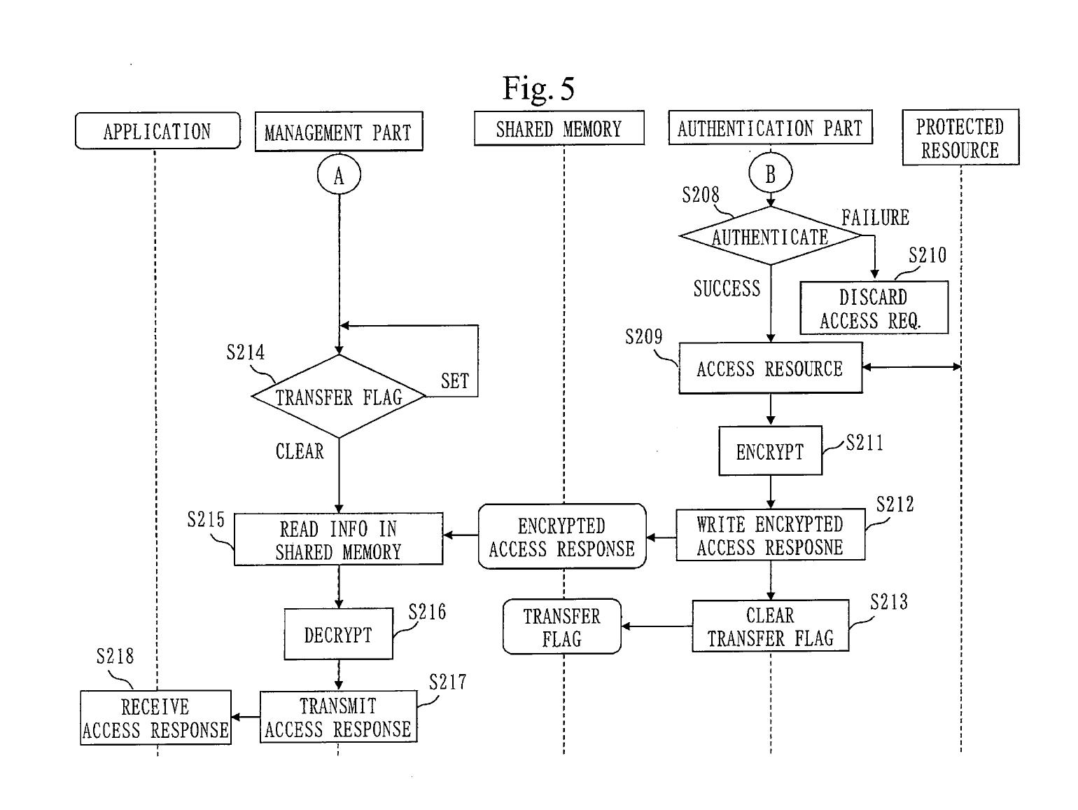

FIGS. 4 and 5 show a process flow of the application program execution device 1 according to this embodiment.

In FIGS. 4 and 5, the application management part 21 is expressed as “management part”.

When the application 5 in the application registration part 3 is actuated and is to access the protected resource 2, the first communication part 8 transmits the access request requesting use of the protected resource 2, to the application management part 21 (S200).

Communication from the application 5 to the application management part 21 is permitted only where, for example, the digital certificate used when installing the application 5 is the same as the digital certificate used when installing the application management part 21.

In the application management part 21, the first communication part 9 receives the access request for the protected resource 2 from the application 5 (S201).

Subsequently, the authentication information generation part 24 generates the authentication information using the authentication key 23, and the encryption part 26 encrypts the access request and the authentication information using the encryption key 25 (S202).

The authentication information generation algorithm can be of any type as far as the authentication information verification part 14 can verify the authentication information.

All of the authentication information and access request need not be encrypted, and only part of the information may be encrypted, unlike in this embodiment.

Information such as a message authentication code or a digital signature that serves for detecting falsification may be added to the authentication information and access request.

The second communication part 10 writes the encrypted access request and authentication information, into the shared memory 20 (S203).

The second communication part 10 sets the transfer flag 30 provided to the shared memory 20 (S204).

In the authentication part 7, the second communication part 11 polls the transfer flag 30 (S205), and reads the information in the shared memory 20 if the transfer flag 30 is set (S206).

Using the encryption key 28, the encryption part 29 decrypts the encrypted authentication information and access request (S207).

Furthermore, the authentication information verification part 14 verifies the authentication information using the authentication key 27, to authenticate whether or not the access request has been transmitted from a legitimate transmission source (that is, the application management part 21) (S208).

The authentication information may be verified by any method.

As the result of authentication in S208, if the authentication is successful, the authentication information verification part 14 accesses the requested resource (S209).

If the authentication fails, the access request is discarded (S210).

At this time, the authentication information verification part 14 may respond to the application management part 21 via the shared memory 20 that the authentication failed.

After that, in the authentication part 7, the encryption part 29 encrypts the access response using the encryption key 28 (S211).

The second communication part 11 writes the encrypted access response into the shared memory 20 (S212), and clears the transfer flag 30 (S213).

In the application management part 21, the second communication part 10 polls the transfer flag 30 (S214), and reads information in the shared memory 20 once the transfer flag 30 is cleared (S215).

After that, the encryption part 26 decrypts the encrypted access response using the encryption key 25 (S216). The first communication part 9 transmits the access response to the application 5 (S217).

In the application 5, the first communication part 8 receives the access response from the application management part 21 (S218).

In this embodiment, the application management part 21 is provided in the application registration part 3. Alternatively, the application management part 21 can be provided separately from the application registration part 3.

Alternatively, the application management part 21 need not be an application, but can be a service operating in the background and not having a user interface.

In this embodiment, the encryption key different from the authentication key is provided. Alternatively, the same key may be used as the authentication key and the encryption key.

In that case, the authentication information generation part 24 generates the authentication information and encrypts/decrypts the authentication information.

In this embodiment, the authentication part 7 authenticates the application management part 21. Alternatively, a process of authenticating the authentication part 7 by the application management part 21 may be added, and the application management part 21 and the authentication part 7 may authenticate each other.

This mutual authentication provides a more secure system to the user.

Also, the authentication part 7 may be provided outside the application program execution device 1, as with an IC card. The application management part 21 in the application program execution device 1 may access a resource in or outside the application program execution device 1 via the external authentication part 7.

Where a plurality of resources exist, identification information on the resource to be accessed may be included in the access request. The authentication part may access the resource that matches the identification information.

As described above, the application 5 accesses the resource via the application management part 21 and the authentication part 7. Hence, authentication information that should be kept secret need not be incorporated in the application 5, so that a secure system can be provided to the user.

An application developer does not need to conduct the security management of the authentication information, and authentication for a plurality of applications can be performed by the single application management part 21. Thus, the application development cost can decrease, so that the service can be provided to the user at a low cost.

As the encryption part is provided in each of the application management part 21 and the authentication part 7, the risk of information leakage from the shared memory 20 decreases, so that a more secure system can be provided to the user.

As the authentication information generation part 24 generates authentication information every time, even an attack reusing the authentication information can be coped with, so that a more secure system can be provided to the user.

### Embodiment 3

The above embodiments explained an authentication process in an actual environment where the application operates on an OS (Operating System), or in a virtual execution environment.

The present embodiment is practiced in an equipment where the virtual execution environment and the actual environment coexist.

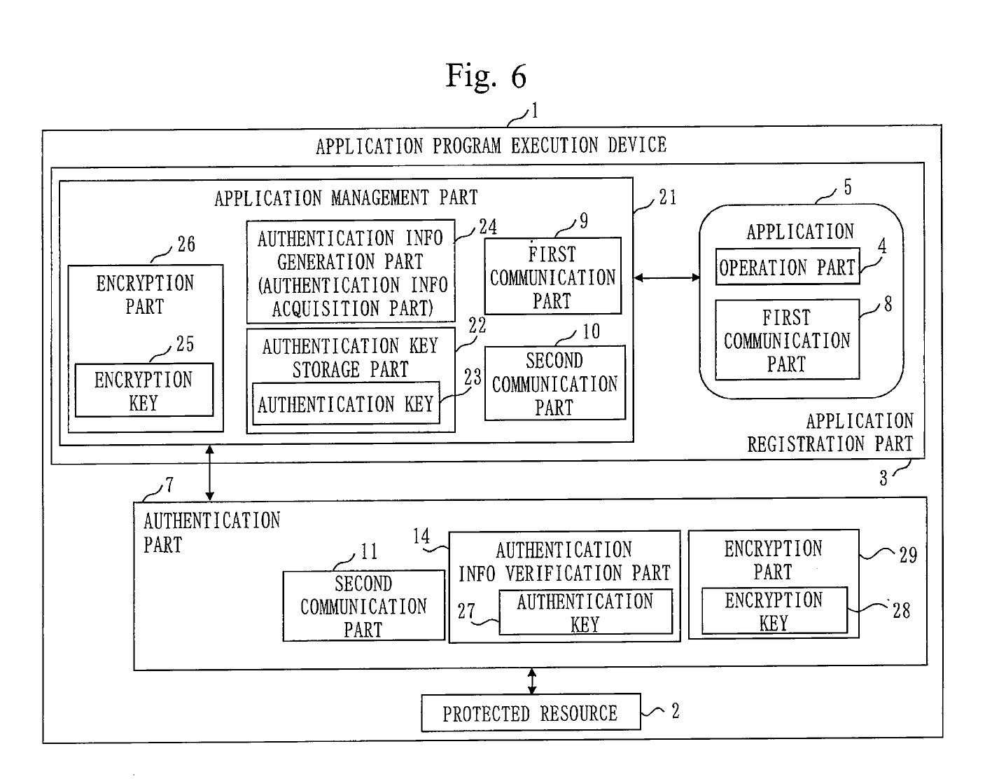

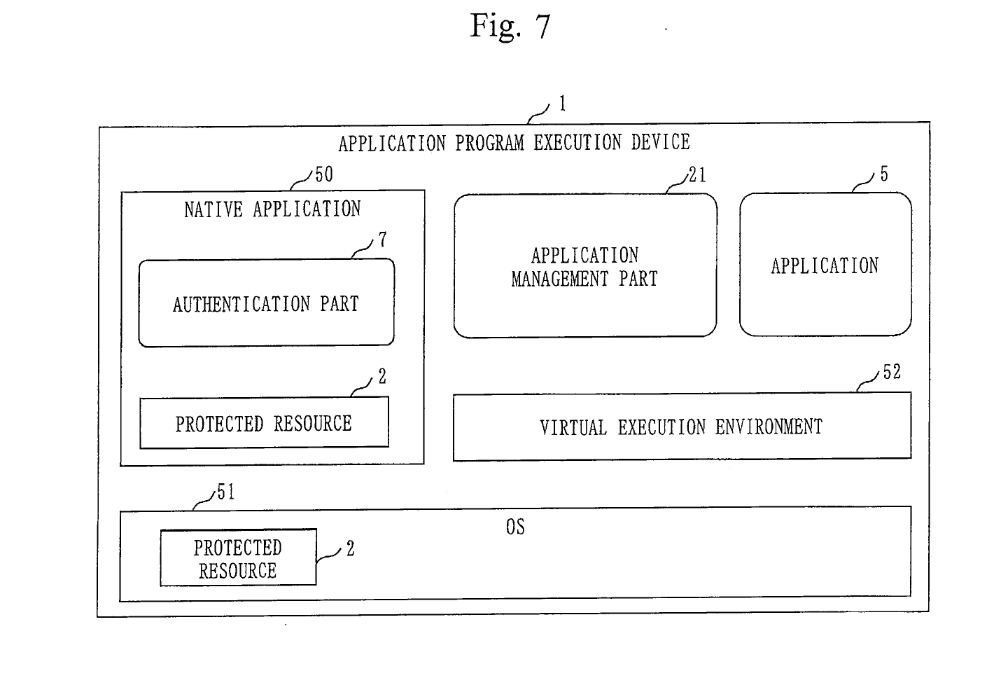

FIG. 6 is a configuration diagram of the application program execution device 1 according to this embodiment, and FIG. 7 is a function conceptual diagram of the application program execution device 1 according to this embodiment.

In the application program execution device 1 according to this embodiment, as shown in FIG. 7, a native application 50 and a virtual execution environment 52 (virtual machine monitor) operate on an OS 51, and the application management part 21 and the application 5 operate on the virtual execution environment 52.

The authentication part 7 is included in the native application 50.

The protected resource 2 is included in each of the native application 50 and the OS 51.

Although the internal configurations of the authentication part 7, application management part 21, and application 5 are not shown in FIG. 7, the internal configurations of the respective elements are as shown in FIG. 6.

Referring to FIG. 6, the application registration part 3 incorporates the application management part 21, as with Embodiment 2.

The application management part 21 has been installed in the application program execution device 1 in advance by the manufacturer of the application program execution device 1, and operates in the virtual execution environment 52.

The internal configuration of the application management part 21 is the same as that shown in Embodiment 2.

In Embodiment 2, the second communication part 10 writes the encrypted authentication information and access request to the shared memory 20. In the present embodiment, the second communication part 10 transmits encrypted authentication information and an encrypted access request to the second communication part 11 of the authentication part 7.

The second communication part 11 may conduct communication using the shared memory 20 shown in Embodiment 2.

As with Embodiment 2, the application management part 21 has no user interface, and the data is not copied or moved to an external storage device such as an SD (registered trademark) card connected to the application program execution device 1.

The configurations of the application 5 and authentication part 7 are the same as those of Embodiment 2.

The operation will be described.

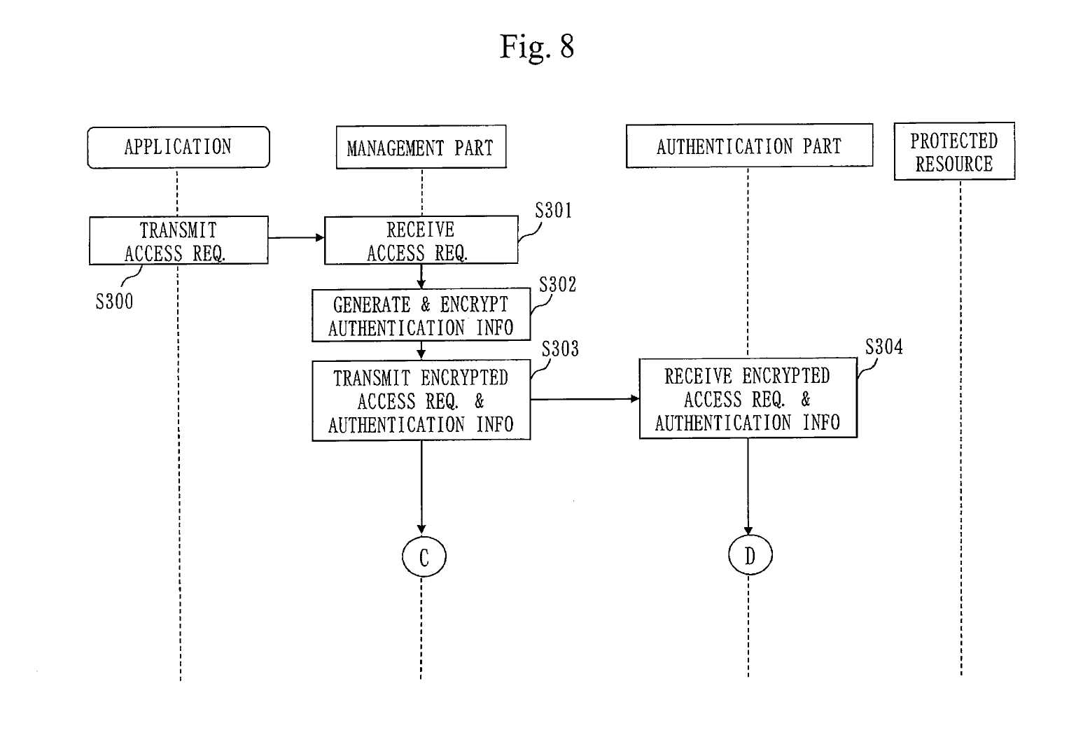

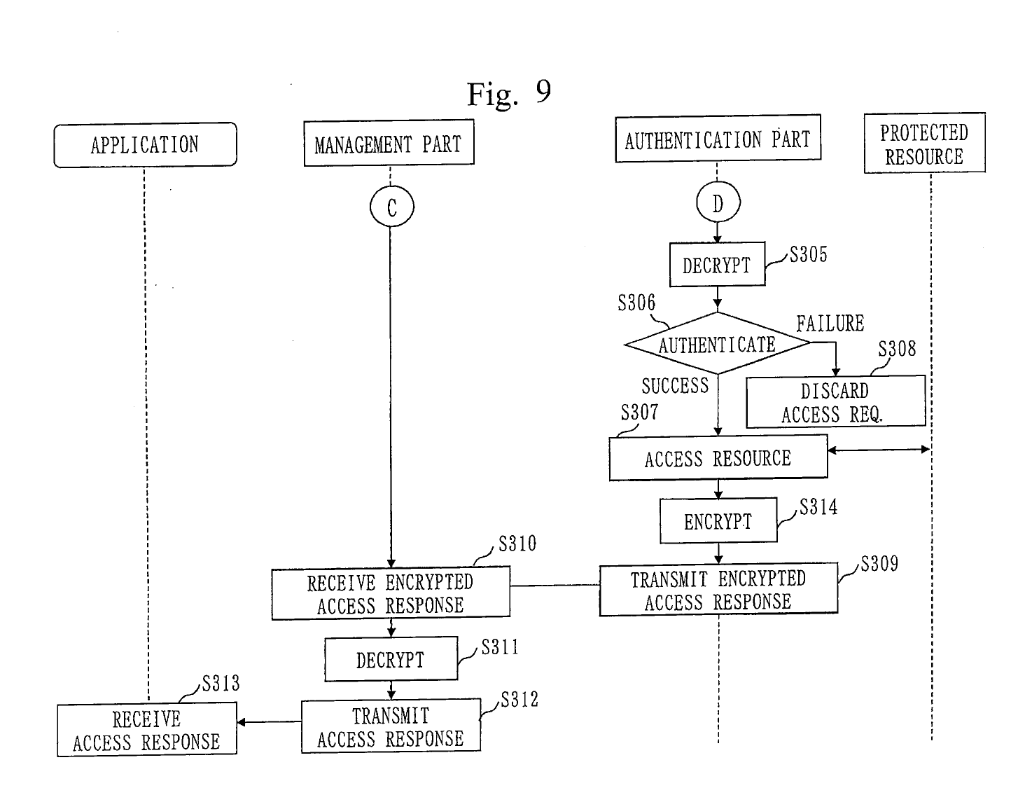

FIGS. 8 and 9 show a process flow of the application program execution device 1 according to this embodiment.

In FIGS. 8 and 9, the application management part 21 is expressed as “management part”.

When the application 5 in the application registration part 3 is actuated and is to access the protected resource 2, the first communication part 8 transmits an access request requesting use of the protected resource 2, to the application management part 21 (S300).

Communication from the application 5 to the application management part 21 is permitted only where, for example, the digital certificate used when installing the application 5 is the same as the digital certificate used when installing the application management part 21.

In the application management part 21, the first communication part 9 receives the access request for the protected resource 2 from the application 5 (S301).

Subsequently, the authentication information generation part 24 generates the authentication information using the authentication key 23, and the encryption part 26 encrypts the access request and the authentication information using the encryption key 25 (S302).

The authentication information generation algorithm can be of any type as far as the authentication information verification part 14 can verify the authentication information.

All of the authentication information and access request need not be encrypted, and only part of the information may be encrypted, unlike in this embodiment.

Information such as a message authentication code or a digital signature that serves for detecting falsification may be added to the authentication information and the access request.

The second communication part 10 transmits the encrypted access request and authentication information to the authentication part 7 (S303).

In the authentication part 7, the second communication part 11 receives the encrypted access request and authentication information from the application management part 21 (S304).

Using the encryption key 28, the encryption part 29 decrypts the encrypted authentication information and access request (S305).

Furthermore, the authentication information verification part 14 verifies the authentication information using the authentication key 27, to authenticate whether or not the access request has been transmitted from a legitimate transmission source (that is, the application management part 21) (S306).

As the result of authentication in S306, if the authentication is successful, the authentication information verification part 14 accesses the requested resource (S307).

If the authentication fails, the access request is discarded (S308).

At this time, the second communication part 11 may respond to the application management part 21 that the authentication failed.

After that, in the authentication part 7, the encryption part 29 encrypts the access response using the encryption key 28 (S308).

The second communication part 11 transmits the encrypted access response to the application management part 21 (S309).

If the access request is information reading or the like, readout information may be included in this response.

In the application management part 21, the second communication part 10 receives the encrypted access response from the authentication part 7 (S310). Using the encryption key 25, the encryption part 26 decrypts the encrypted access response (S311). The first communication part 9 transmits the access response to the application 5 (S312).

In the application 5, the first communication part 8 receives the access response from the application management part 21 (S313).

The application management part 21 need not be an application, but can be a service operating in the background and not having a user interface.

In this embodiment, the encryption key different from the authentication key is provided. Alternatively, the same key may be used as the authentication key and the encryption key.

In that case, the authentication information generation part 24 generates the authentication information and encrypts/decrypts the authentication information.

The encryption part 29 can be provided in the virtual execution environment 52 instead of in the application management part 21. The encryption part in the virtual execution environment 52 may be used.

Likewise, the encryption part 29 can be provided in the OS 51 instead of in the authentication part 7. The encryption part in the OS 51 can be used.

The authentication information generation part 24 of the application management part 21 may generate authentication information using the encryption part in the virtual execution environment 52.

Likewise, the authentication information verification part 14 of the authentication part 7 may verify the authentication information using the encryption part in the OS 51.

In this embodiment, the authentication part 7 authenticates the application management part 21. Alternatively, a process of authenticating the authentication part 7 by the application management part 21 may be added, and the application management part 21 and the authentication part 7 may authenticate each other.

This mutual authentication provides a more secure system to the user.

Also, the authentication part 7 may be provided outside the application program execution device 1, as with an IC card. The application management part 21 in the application program execution device 1 may access a resource in or outside the application program execution device 1 via the external authentication part 7.

Where a plurality of resources exist, identification information on the resource to be accessed may be included in the access request. The authentication part may access the resource that matches the identification information.

As described above, the application 5 accesses the resource via the application management part 21 and the authentication part 7. Hence, authentication information that should be kept secret need not be incorporated in the application 5, so that a secure system can be provided to the user.

An application developer does not need to conduct the security management of the authentication information, and authentication for a plurality of applications can be performed by the single application management part 21. Thus, the application development cost can decrease, so that the service can be provided to the user at a low cost.

As the encryption part is provided in each of the application management part 21 and the authentication part 7, the risk of information leakage from the shared memory 20 decreases, so that a more secure system can be provided to the user.

As the authentication information generation part 24 generates authentication information every time, even an attack reusing the authentication information can be coped with, so that a more secure system can be provided to the user.

Also, according to this embodiment, a resource different from the resource protected in the virtual execution environment can be protected, so that a variety of services can be provided to the user securely.

### Embodiment 4

The above embodiments have shown an example where the authentication part 7 is located inside the application program execution device 1.

The present embodiment shows an example where the authentication part 7 is provided outside the application program execution device 1.

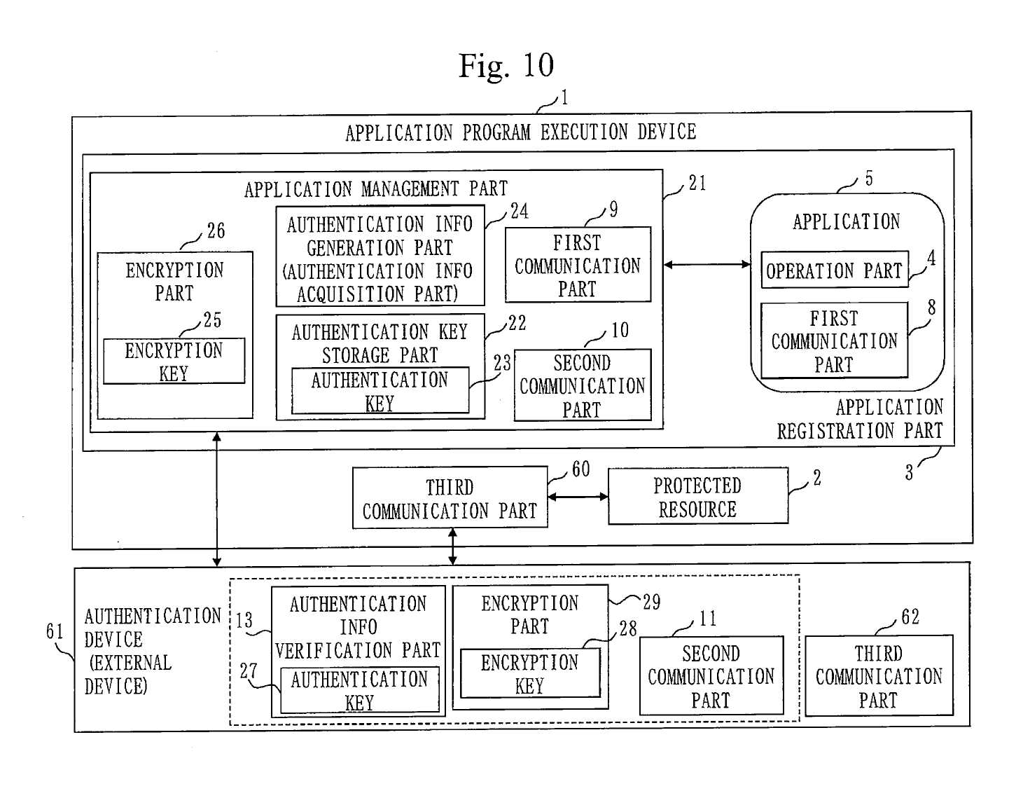

FIG. 10 is a configuration diagram of the application program execution device 1 according to this embodiment.

In this embodiment, the function of the authentication part 7 indicated in Embodiments 1 to 3 is provided outside the application program execution device 1, as an authentication device 61.

The authentication device 61 is an example of an external device.

The authentication device 61 can be implemented by, for example, an IC card.

A portion surrounded by a broken line in FIG. 10 corresponds to the authentication part 7 indicated in Embodiments 1 to 3.

In this embodiment, the authentication device 61 is provided with a third communication part 62 adapted to communicate with a third communication part 60 of the application program execution device 1.

The other elements in the authentication device 61 are the same as those that have already been described, and their description will accordingly be omitted.

The application program execution device 1 is constituted by the protected resource 2, the application registration part 3 including the application 5 and the application management part 21, and the third communication part 60 for accessing the protected resource 2.

The application 5 and the application management part 21 are the same as those indicated in Embodiment 3, and their description will accordingly be omitted.

The operation is the same as those in the process flow of FIGS. 8 and 9 of Embodiment 3 except that the operation of the authentication part 7 is executed by the authentication device 61, and that access (S307) of the authentication part 7 to the protected resource 2 is executed via the third communication part 62 and the third communication part 60. Therefore, the description will be omitted.

The application management part 21 need not be an application, but can be a service operating in the background and not having a user interface.

In this embodiment, the encryption key different from the authentication key is provided. Alternatively, the same key may be used as the authentication key and the encryption key.

In that case, the authentication information generation part 24 generates the authentication information and encrypts/decrypts the authentication information.

In this embodiment, the authentication device 61 authenticates the application management part 21. Alternatively, a process of authenticating the authentication device 61 by the application management part 21 may be added, and the application management part 21 and the authentication device 61 may authenticate each other.

This mutual authentication provides a more secure system to the user.

In this embodiment, a resource in the application program execution device 1 is accessed. Alternatively, the same effect can be obtained with a configuration in which a resource outside the application program execution device 1 is accessed.

Where a plurality of resources exist, identification information on the resource to be accessed may be included in the access request. The authentication part may access the resource that matches the identification information.

As described above, if an authentication device is provided outside the application program execution device 1, the same effect as those of the embodiments described above can be obtained.

### Embodiment 5

In the above embodiments, the application accesses the resource via the application management part or the authentication part. An embodiment will now be described in which the application accesses the resource not via the application management part but via the authentication part, using information obtained from the application management part.

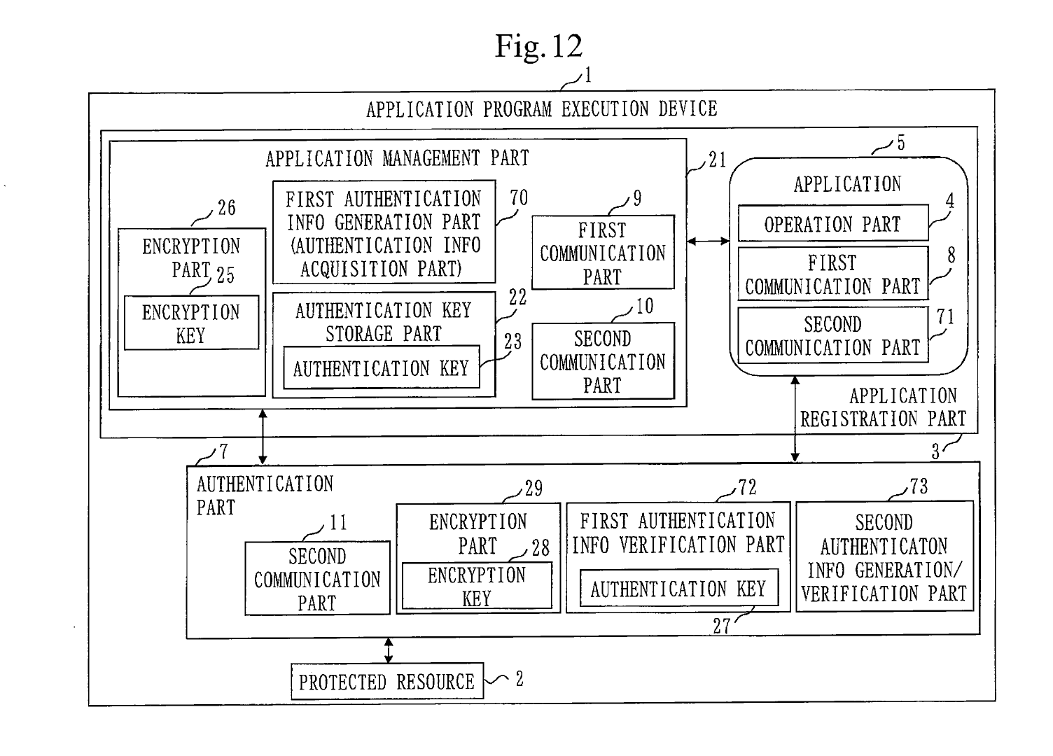

FIG. 12 shows a configuration example of the application program execution device 1 according to this embodiment.

The basic configuration of the application program execution device 1 of this embodiment is the same as that of FIG. 6, and is roughly grouped into the protected resource 2, the application registration part 3, and the authentication part 7.

The application registration part 3 incorporates the application management part 21 in the same manner as in Embodiment 3.

The application management part 21 is an application that has been installed in the application program execution device 1 in advance by the manufacturer of the application program execution device 1.

The application management part 21 has no user interface, and the data is not copied or moved to an external storage device such as an SD (registered trademark) card connected to the application program execution device 1.

The application management part 21 of this embodiment includes a first authentication information generation part 70 which, as the authentication information generation part 24 of Embodiment 3 does, generates first authentication information using the authentication key 23 of the authentication key storage part 22.

The first authentication information is used to verify the legitimacy of the application management part 21, as with Embodiment 1.

In this embodiment, the first authentication information generation part 70 is an example of the authentication information acquisition part.

The application 5 is an application that was downloaded later on, as with Embodiment 1.

The application 5 includes a second communication part 71. The second communication part 71 communicates with the second communication part 11 of the authentication part 7.

The second communication part 71 can perform communication using the shared memory shown in Embodiment 2.

The internal configuration except for the second communication part 71 is the same as that in Embodiment 1, and its description will accordingly be omitted.

In the authentication part 7, a first authentication information verification part 72 verifies the received first authentication information using the authentication key 27.

The encryption part 29 conducts encryption and decryption using the encryption key 28.

The second communication part 11 communicates with the application management part 21 and the application 5.

A second authentication information generation/verification part 73 generates second authentication information to be used in communication with the application 5, and verifies the second authentication information received from the application 5.

The second authentication information in this embodiment can be implemented by a password.

The operation will be described.

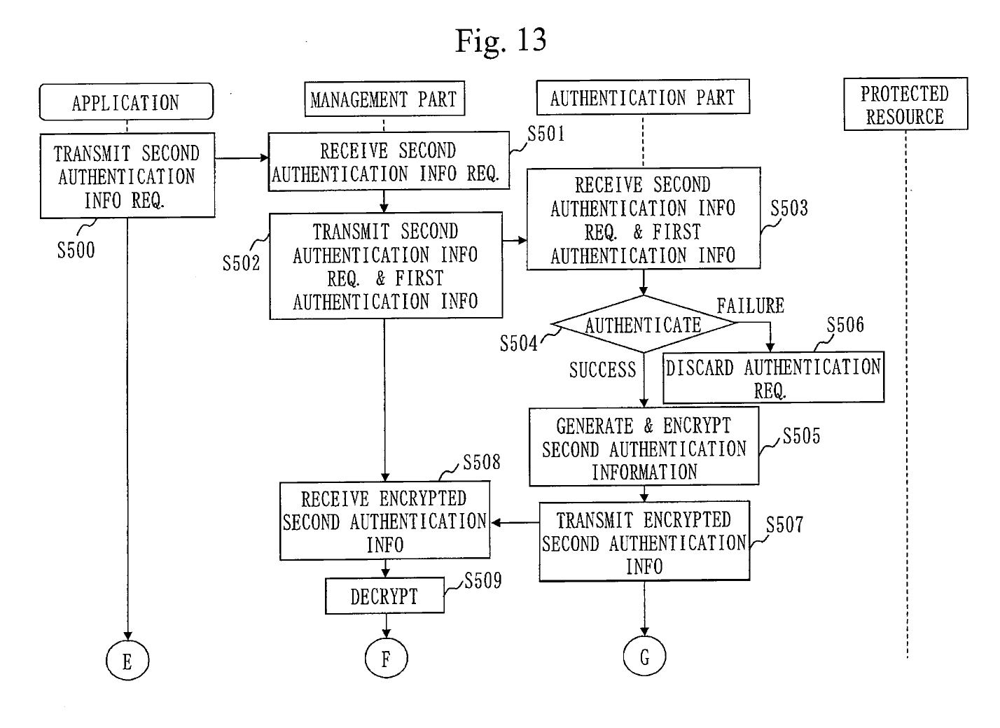

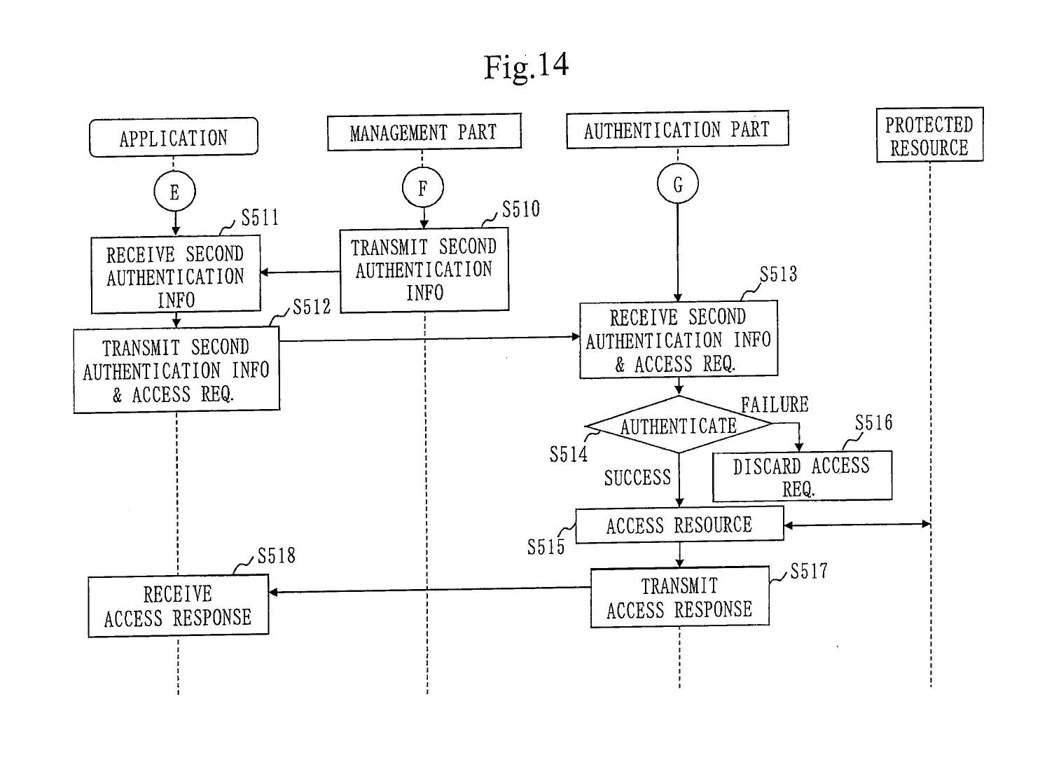

FIGS. 13 and 14 show a process flow of the application program execution device 1 according to this embodiment.

In FIGS. 13 and 14, the application management part 21 is expressed as “management part”.

When the application 5 in the application registration part 3 is actuated and is to access the protected resource 2, the first communication part 8 transmits a second authentication information request requesting the second authentication information to be employed when using the protected resource 2, to the application management part 21 (S500).

Communication from the application 5 to the application management part 21 is permitted only where, for example, the digital certificate used when installing the application 5 is the same as the digital certificate used when installing the application management part 21.

In the application management part 21, the first communication part 9 receives the second authentication information request from the application (S501).

Subsequently, in the application management part 21, the first authentication information generation part 70 generates the first authentication information using the authentication key 23, and the second communication part 10 transmits the first authentication information and the second authentication information request to the authentication part 7 (S502).

The first authentication information generation algorithm can be of any type as far as the first authentication information verification part 72 can verify the first authentication information.

At this time, the encryption part 29 may encrypt the first authentication information using an encryption key.

Information such as a message authentication code or a digital signature that serves for detecting falsification may be added to the first authentication information.

In the authentication part 7, the second communication part 11 receives the first authentication information from the application management part 21 (S503).

The first authentication information verification part 72 verifies the first authentication information using the authentication key 27, to authenticate whether or not the second authentication information request has been transmitted from a legitimate transmission source (that is, the application management part 21) (S504).

As the result of authentication in S504, if the authentication is successful, in the authentication part 7, the second authentication information generation/verification part 73 generates the second authentication information, and the encryption part 29 encrypts the second authentication information using the encryption key 28 (S505).

If the authentication fails, the first authentication information verification part 72 discards the second authentication information request (S506).

At this time, the second communication part 11 may respond to the application management part 21 that the authentication failed.

Then, the second communication part 11 transmits the encrypted second authentication information to the application management part 21 (S507).

In the application management part 21, the second communication part 10 receives the encrypted second authentication information from the authentication part 7 (S508). Using the encryption key 25, the encryption part 26 decrypts the encrypted second authentication information (S509). The first communication part 9 transmits the second authentication information to the application 5 (S510).

In the application 5, the first communication part 8 receives the second authentication information from the application management part 21 (S511).

After that, in the application 5, the second communication part 71 transmits the second authentication information and an access request requesting use of the protected resource, to the authentication part 7 (S512).

In the authentication part 7, the second communication part 11 receives the second authentication information and the access request (S513).

The second authentication information generation/verification part 73 verifies the received second authentication information, thereby authenticating whether or not the access request has been transmitted from a legitimate transmission source (that is, the application 5) (S514).

As the result of the authentication of S514, if the authentication is successful, the authentication part 7 accesses the requested resource (S515).

If the authentication fails, the authentication part 7 discards the access request (S516).

At this time, the second communication part 11 may respond to the application 5 that the authentication failed.

Then, the second communication part 11 transmits an access response to the application 5 (S517).

If the access request is information reading or the like, readout information may be included in this response.

In the application 5, the second communication part 71 receives the access response from the authentication part 7 (S518).

The application management part 21 need not be an application, but can be a service operating in the background and not having a user interface.

In this embodiment, the encryption key different from the authentication key is provided. Alternatively, the same key may be used as the authentication key and the encryption key.

In that case, the first authentication information verification part 72 generates the authentication information and encrypts/decrypts the authentication information.

The encryption part 26 can be provided in the virtual execution environment of Embodiment 3 instead of in the application management part 21. The encryption part in the virtual execution environment may be used.

Likewise, the encryption part 29 can be provided in the OS instead of in the authentication part 7. The encryption part located in the OS can be used.

The first authentication information generation part 70 of the application management part 21 can generate the first authentication information using the encryption part located in the virtual execution environment of Embodiment 3.

Likewise, the first authentication information verification part 72 and the second authentication information generation/verification part 73 of the authentication part 7 can verify the first authentication information and generate and verify the second authentication information, using the encryption part in the OS.

In this embodiment, the authentication part 7 authenticates the application management part 21. Alternatively, a process of authenticating the authentication part 7 with the application management part 21 may be added, and the application management part 21 and the authentication part 7 may authenticate each other.

This mutual authentication provides a more secure system to the user.

Also, the authentication part 7 may be provided outside the application program execution device 1, as with an IC card. The application management part 21 in the application program execution device 1 may access a resource in or outside the application program execution device 1 via the external authentication part.

In this embodiment, a flow has been explained in which after the application management part 21 receives the second authentication information request from the application 5, the authentication part 7 conducts authentication using the first authentication information.

Alternatively, before the application management part 21 receives the second authentication information request from the application 5, when, for example, the power supply of the application program execution device 1 is turned on, the authentication part 7 may authenticate the application management part 21 using the first authentication information, and the application management part 21 may acquire the second authentication information. When a second authentication information request is received from the application 5, the application management part 21 may respond to the application 5 with the acquired second authentication information.

An authentication process may not be performed for subsequent access requests, or an authentication process may not be performed for an access request issued within a predetermined period of time since authentication.

Furthermore, the application 5 may store the second authentication information acquired from the application management part 21, and use the second authentication information every time the application 5 transmits an access request to the authentication part 7.

The second authentication information to be transferred from the application management part 21 to the application 5 may be a common key that matches a keyed message authentication code or encryption.

In this case, the application 5 needs to generate authentication information from the received common key.

In this embodiment, the second authentication information is generated by the authentication part 7. Alternatively, the second authentication information may be generated by the application management part 21, or by both of the application management part 21 and the authentication part 7.

In the latter case, the second authentication information can be generated using, for example, the first authentication information, by the application management part 21 and authentication part 7 having the same generation mechanism.

As described above, the application, after being downloaded, obtains the second authentication information from the application management part, and the authentication part authenticates the second authentication information, and accesses the resource.

Hence, authentication information that should be kept secret need not be incorporated in an application, which can be downloaded by anybody, on the application distribution server, so that a secure system can be provided to the user.

As the encryption part is provided in each of the application management part and the authentication part, the risk of information leakage during the communication between the application management part and the authentication part decreases, so that a more secure system can be provided to the user.

As the application can access the resource not via the application management part, the access to the resource can be realized efficiently using fewer memories than in the embodiments described above, leading to a cost reduction.

### Embodiment 6

Embodiment 5 has indicated a configuration in which the application management part transmits the second authentication information generated by the authentication part to the application. An embodiment will now be indicated in which the application management part generates the second authentication information using the second authentication key generated by the authentication part.

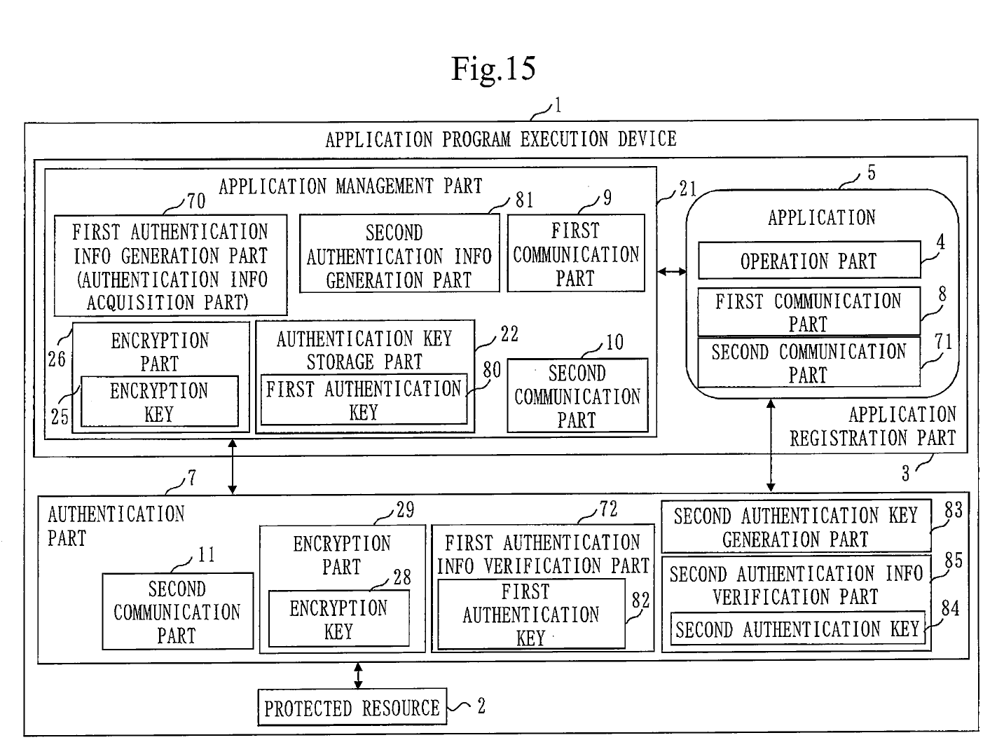

FIG. 15 shows a configuration example of the application program execution device 1 according to this embodiment.

The basic configuration of the application program execution device 1 of this embodiment is the same as that of FIG. 12, and is roughly grouped into the protected resource 2, the application registration part 3, and the authentication part 7.

The application registration part 3 incorporates the application management part 21 in the same manner as in Embodiment 5.

The application management part 21 of this embodiment includes the first authentication information generation part 70 which, as the authentication information generation part 24 of Embodiment 3 does, generates first authentication information using a first authentication key 80 of the authentication key storage part 22.

The first authentication information is used to verify the legitimacy of the application management part 21, as with Embodiment 1.

In this embodiment as well, the first authentication information generation part 70 is an example of the authentication information acquisition part.

A second authentication information generation part 81 generates second authentication information using a second authentication key 84 received from the authentication part 7.

The second authentication key 84 can be a key of a common key algorithm, or a public key/secret key of a public key algorithm. In the former case, the second authentication information is encrypted data or a keyed message authentication code; in the later case, a digital certificate, a digital signature, or encrypted data.

Except for them, the internal configuration is the same as those of the other embodiments, and its description will accordingly be omitted.

The application 5 is an application downloaded later on, as in Embodiment 1. Since the internal configuration of the application 5 is the same as that of Embodiment 5, its description will accordingly be omitted.

In the authentication part 7, the first authentication information verification part 72 verifies the received first authentication information using a first authentication key 82.

A second authentication key generation part 83 generates the second authentication key 84.

A second authentication information verification part 85 verifies the received second authentication information using the second authentication key 84.

Except for the above, the internal configuration of the authentication part 7 is the same as that of Embodiment 5, and its description will accordingly be omitted.

The operation will be described.

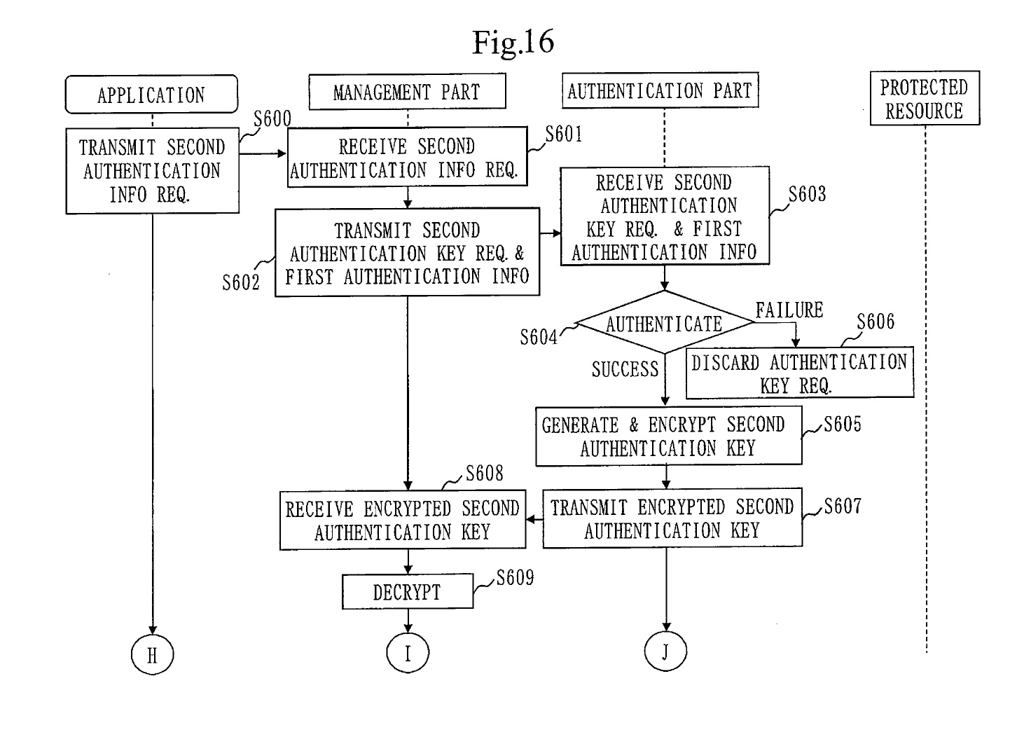

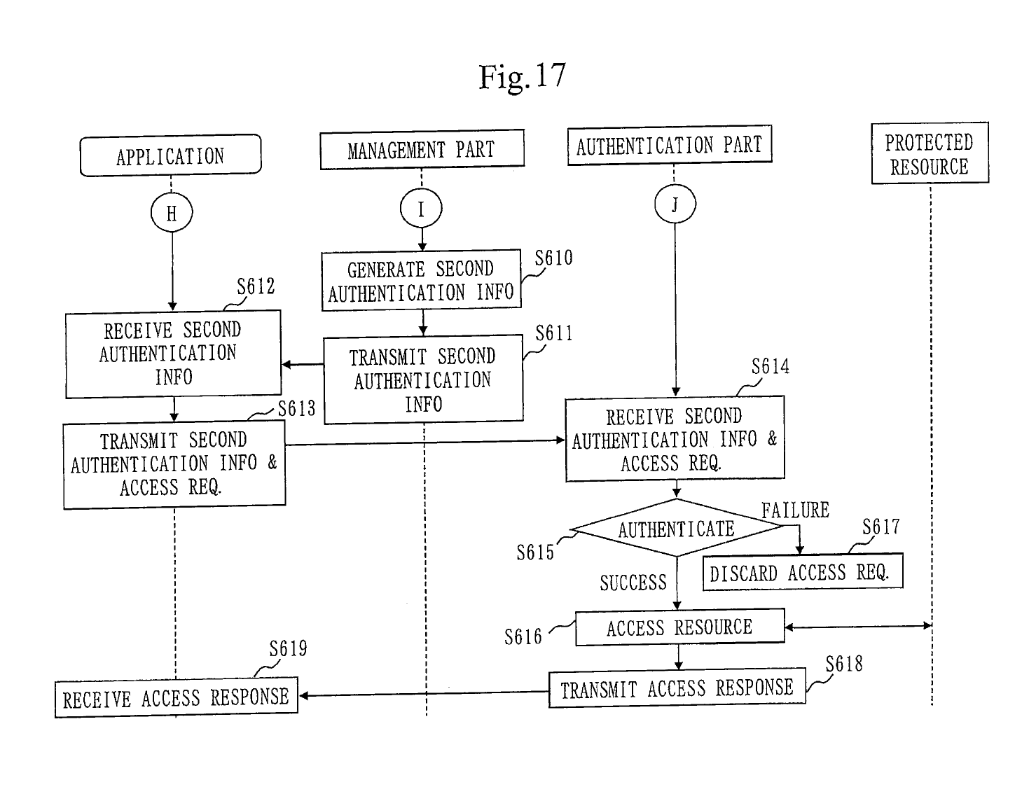

FIGS. 16 and 17 show a process flow of the application program execution device 1 according to this embodiment.

In FIGS. 16 and 17, the application management part 21 is expressed as “management part”.

When the application 5 in the application registration part 21 is actuated and is to access the protected resource 2, the first communication part 8 transmits a second authentication information request requesting the second authentication information to be employed when using the protected resource 2, to the application management part 21 (S600).

Depending on the second authentication information, the application 5 may transmit an access request instruction and transmission data which are to be transmitted to the authentication part 7 later, or part of the same, to the application management part 21.

Communication from the application 5 to the application management part 21 is permitted only where, for example, the digital certificate used when installing the application 5 is the same as the digital certificate used when installing the application management part 21.

In the application management part 21, the first communication part 9 receives the second authentication information request from the application (S601).

Subsequently, in the application management part 21, the first authentication information generation part 70 generates the first authentication information using the first authentication key 80, and the second communication part 10 transmits the first authentication information and a second authentication key request which requests a second authentication key, to the authentication part 7 (S602).

The first authentication information generation algorithm can be of any type as far as the first authentication information verification part 72 can verify the first authentication information.

At this time, the encryption part 26 may encrypt the first authentication information using the encryption key 25.

Information such as a message authentication code or a digital signature that serves for detecting falsification may be added to the first authentication information.

In the authentication part 7, the second communication part 11 receives the first authentication information and the second authentication key request from the application management part 21 (S603).

The first authentication information verification part 72 verifies the first authentication information using the first authentication key, to authenticate whether or not the second authentication key request has been transmitted from a legitimate transmission source (that is, the application management part 21) (S604).

As the result of authentication in S604, if the authentication is successful, in the authentication part 7, the second authentication key generation part 83 generates the second authentication key 84, and the encryption part 29 encrypts the second authentication key 84 using the encryption key 28 (S605).

If the authentication fails, the first authentication information verification part 72 discards the second authentication key request (S606).

At this time, the second communication part 11 may respond to the application management part 21 that the authentication failed.

Then, the second communication part 11 transmits the encrypted second authentication key to the application management part 21 (S607).

In the application management part 21, the second communication part 10 receives the encrypted second authentication key from the authentication part 7 (S608). Using the encryption key, the encryption part 26 decrypts the encrypted second authentication key (S609).

After that, the second authentication information generation part 81 generates the second authentication information, (S610), and the first communication part 9 transmits the second authentication information to the application 5 (S611).

In the application 5, the first communication part 8 receives the second authentication information from the application management part 21 (S612).

After that, in the application 5, the second communication part 71 transmits the second authentication information and an access request requesting use of the protected resource, to the authentication part 7 (S613).

In the authentication part 7, the second communication part 11 receives the second authentication information and the access request (S614).

The second authentication information verification part 85 verifies the received second authentication information, thereby authenticating whether or not the access request has been transmitted from a legitimate transmission source (that is, the application 5) (S615).

As the result of the authentication of S615, if the authentication is successful, the authentication part 7 accesses the requested resource (S616).

If the authentication fails, the authentication part 7 discards the access request (S617).

At this time, the second communication part 11 may respond to the application 5 that the authentication failed.

Then, the second communication part 11 transmits an access response to the application 5 (S618).

If the access request is information reading or the like, the readout information may be included in this response.

In the application 5, the second communication part 71 receives the access response from the authentication part 7 (S619).

The application management part 21 need not be an application, but can be a service operating in the background and not having a user interface.

In this embodiment, the encryption key different from the authentication key is provided. Alternatively, the same key may be used as the authentication key and the encryption key.

In that case, the first authentication information generation part 70 generates the authentication information and encrypts/decrypts the authentication information.

The encryption part can be provided in the virtual execution environment of Embodiment 3 instead of in the application management part. The encryption part located in the virtual execution environment may be used.

Likewise, the encryption part can be provided in the OS instead of in the authentication part 7. The encryption part located in the OS can be used.

The first authentication information generation part 70 of the application management part 21 can generate the first authentication information using the encryption part located in the virtual execution environment of Embodiment 3.

Likewise, the first authentication information verification part 72 and the second authentication information generation/verification part 73 of the authentication part 7 can verify the first authentication information and generate and verify the second authentication information, using the encryption part in the OS.

In this embodiment, the authentication part 7 authenticates the application management part 21. Alternatively, a process of authenticating the authentication part 7 with the application management part 21 may be added, and the application management part 21 and the authentication part 7 may authenticate each other.

This mutual authentication provides a more secure system to the user.

Also, the authentication part 7 may be provided outside the application program execution device 1, as with an IC card. The application management part 21 in the application program execution device 1 may access a resource in or outside the application program execution device 1 via the external authentication part 7.

In this embodiment, a flow has been explained in which after the application management part 21 receives the second authentication information request from the application 5, the authentication part 7 conducts authentication using the first authentication information.

Alternatively, before the application management part 21 receives the second authentication information request from the application 5, when, for example, the power supply of the application program execution device 1 is turned on, the authentication part 7 may authenticate the application management part 21 using the first authentication information, and the application management part 21 may acquire the second authentication key. When the second authentication information request from the application 5 is received, the application management part 21 may generate the second authentication information using the second authentication key acquired by the application management part 21, and respond to the application 5 with the second authentication information.

Alternatively, an authentication process may not be performed for subsequent access requests, or an authentication process may not be performed for an access request issued within a predetermined period of time since the power supply is turned on.

With the above configuration, the same effect as those of the above embodiments can also be obtained.

### Embodiment 7

In the above embodiments, the application transmits the second authentication information to the authentication part. An embodiment will now be indicated in which the authentication part determines the validity of the second authentication information before verifying the second authentication information.

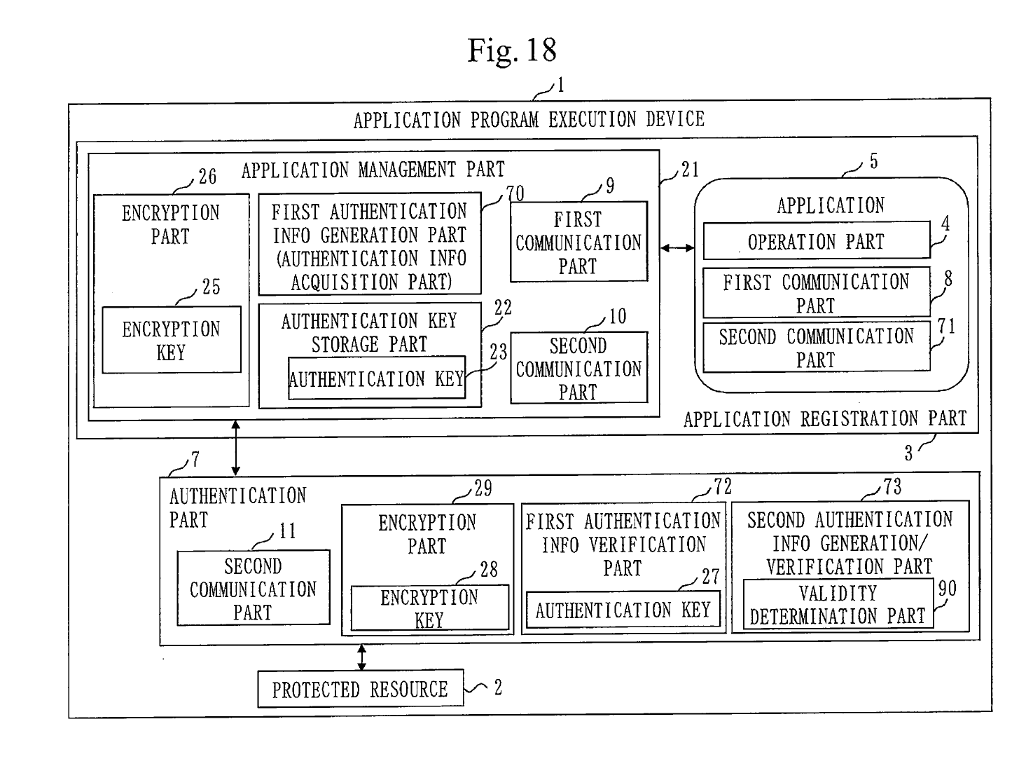

FIG. 18 shows a configuration example of the application program execution device 1 according to this embodiment.

The basic configuration of the application program execution device 1 of this embodiment is the same as that of FIG. 12.

The second authentication information generation/verification part 73 of the authentication part 7 is provided with a validity determination part 90 which determines the validity of second authentication information.

To determine the validity, the number of times of authentication, the time, date, and the like are employed.

For example, regarding the number of times of authentication, the number of times of authentication that uses second authentication information generated by the authentication part 7 is counted. If the count is equal to or less than a prescribed value, the second authentication information is determined valid. If the count exceeds the prescribed value, the second authentication information is determined invalid.

Alternatively, if the current time is within a certain prescribed time since the time the authentication part 7 generated the second authentication information, the second authentication information may be determined valid; if the certain prescribed time has already passed, the second authentication information may be determined invalid.

Alternatively, the second authentication information may be determined valid only for the day the authentication part 7 generated it, or only within a validity term set for it, as with a digital certificate, and may be determined invalid after the expiration of the validity term.

Alternatively, the validity/invalidity may be determined randomly based on random numbers generated by the authentication part 7. Also, the above criteria may be combined.

The operation will be described.

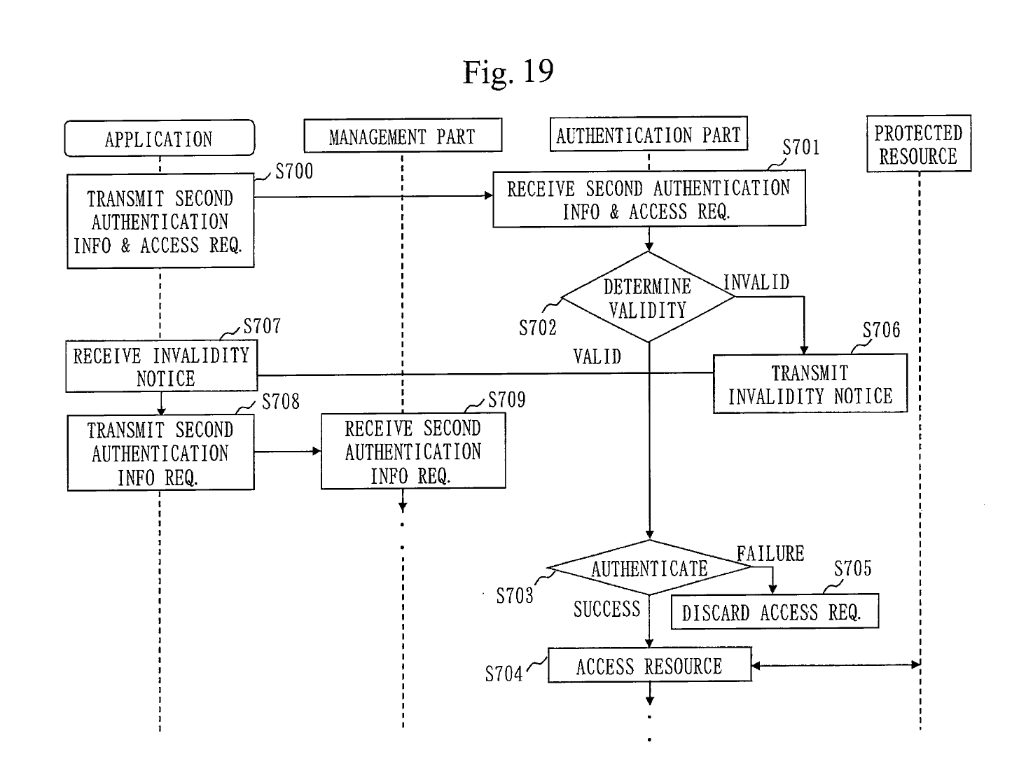

FIG. 19 shows a process flow of the application program execution device 1 according to this embodiment.

FIG. 19 shows part of the process flow. A process flow of acquiring the second authentication information by the application 5 from the application management part 21 is the same as that in FIGS. 16 and 17, and its description is omitted in FIG. 19.

In FIG. 19, the application management part 21 is expressed as “management part”.

When the application 5 in the application registration part 3 is actuated and is to access the protected resource 2, the application 5 acquires the second authentication information from the application management part 21 in the same manner as in FIGS. 16 and 17.

After acquiring the second authentication information, the application 5 transmits, from the second communication part 71, the second authentication information and an access request requesting use of the protected resource, to the authentication part 7 (S700).

In the authentication part 7, the second communication part 11 receives the second authentication information and the access request (S701).

The validity determination part 90 of the second authentication information generation/verification part 73 determines the validity of the second authentication information (S702).

As the result of the determination, if the second authentication information is valid, the second authentication information generation/verification part 73 verifies the received second authentication information, to authenticate whether or not the access request has been transmitted from a legitimate transmission source (that is, the application 5) (S703).

If the result of the authentication of S703 indicates a success, the authentication part 7 accesses the requested resource (S704), and the second communication part 11 transmits the access response to the application 5 (the same process as in FIG. 17 is conducted).

If the authentication fails, the second authentication information generation/verification part 73 discards the access request (S705).

At this time, the second communication part 11 may respond to the application 5 that the authentication failed.

If the result of the determination of S702 indicates invalid, the second communication part 11 transmits an invalidity notice to the application 5 (S706).

In the application 5, when the second communication part 71 receives the invalidity notice from the authentication part 7 (S707), a second authentication information request is transmitted from the first communication part 8 to the application management part 21, in order to acquire new second authentication information (S708).

In the application management part 21, when the first communication part 9 receives the second authentication information (S709), the same process as in FIGS. 16 and 17 is conducted, and the new second authentication information is transmitted to the application 5.

In this embodiment, a flow has been explained in which after the application management part 21 receives the second authentication information request from the application 5, the authentication part 7 conducts authentication using the first authentication information.

Alternatively, before the application management part 21 receives the second authentication information request from the application 5, when, for example, the power supply of the application program execution device 1 is turned on, the authentication part 7 may authenticate the application management part 21 using the first authentication information, and the application management part 21 may acquire the second authentication information. When the second authentication information request from the application 5 is received, the application management part 21 may respond to the application 5 with the acquired second authentication information.

In this embodiment, the second authentication information is generated by the application management part 21. Alternatively, the second authentication information may be generated by both the application management part 21 and the authentication part 7.

This can be realized by generating the second authentication information by the application management part 21 and the authentication part 7 having the same generation mechanism, using, for example, the first authentication information.

This embodiment has indicated a configuration in which the application 5 accesses the resource not via the application management part 21 but via the authentication part 7 using the information obtained from the application management part 21. This embodiment can also be applied to a configuration in which the application 5 accesses the resources via the application management part 21 and the authentication part 7.

As described above, the application 5 obtains the second authentication information from the application management part 21 after the application 5 is downloaded, and the authentication part 7 authenticates the second authentication information and then accesses the resource. Hence, authentication information that should be kept secret need not be incorporated in an application on the application distribution server that can be downloaded by anybody, so that a secure system can be provided to the user.

As the application 5 can access the resource not via the application management part 21, the access to the resource can be realized efficiently using fewer memories than in the embodiments described above, leading to a cost reduction.

The application 5 need not acquire second authentication information every time it accesses the resource. Also, the validity of the second authentication information is determined by the authentication part 7. Thus, a system that is capable of a secure and high-speed resource acquisition process can be realized.

### Embodiment 8

The above embodiments explained a configuration in which an access to a resource by an application is permitted.

An embodiment will be described where accesses to a plurality of resources by a plurality of applications are permitted finely.

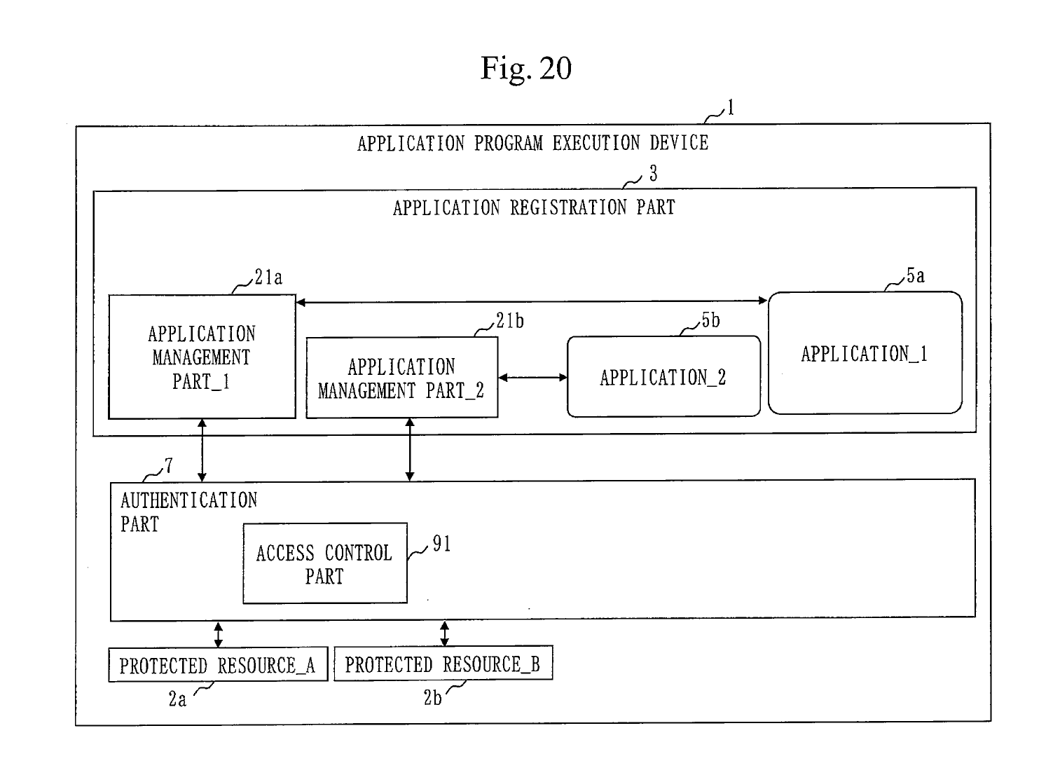

FIG. 20 is a configuration diagram of the application program execution device 1 according to this embodiment.

Referring to FIG. 20, the application registration part 3 incorporates the application management part 21 and the application 5, in the same manner as in the other embodiments. In FIG. 20, two application management parts 21, namely the application management part 21a and the application management part 21b, and two applications 5, namely the application 5a and the application 5b, are included.

The application management part 21a corresponds to the application 5a and manages use of the resource by the application 5a.

Similarly, the application management part 21b corresponds to the application 5b and manages use of the resource by the application 5b.

In the following description, the application management part 21a and the application management part 21b are collectively expressed as the application management part 21 where they need not be distinguished, and the application 5a and the application 5b are collectively expressed as the application 5 where they need not be distinguished.

The application management part 21 has been installed in the application program execution device 1 in advance by the manufacturer of the application program execution device 1.

This embodiment also includes, as the resource, a resource_A 2a and a resource_B 2b.

The internal configuration of the application management part 21 is the same as those described in the other embodiments.

As with the other embodiments, the application management part 21 has no user interface, and the data is not copied or moved to an external storage device such as an SD (registered trademark) card connected to the application program execution device 1.

The authentication part 7 has an access control part 91 which controls access to the resource A and the resource B depending on the application management part 21 that transmits an access request.

Although the internal configurations of the authentication part 7, application management part 21, and application 5 are omitted in FIG. 20, the internal configurations of the respective elements are as indicated in FIG. 6.

The operation will be described.

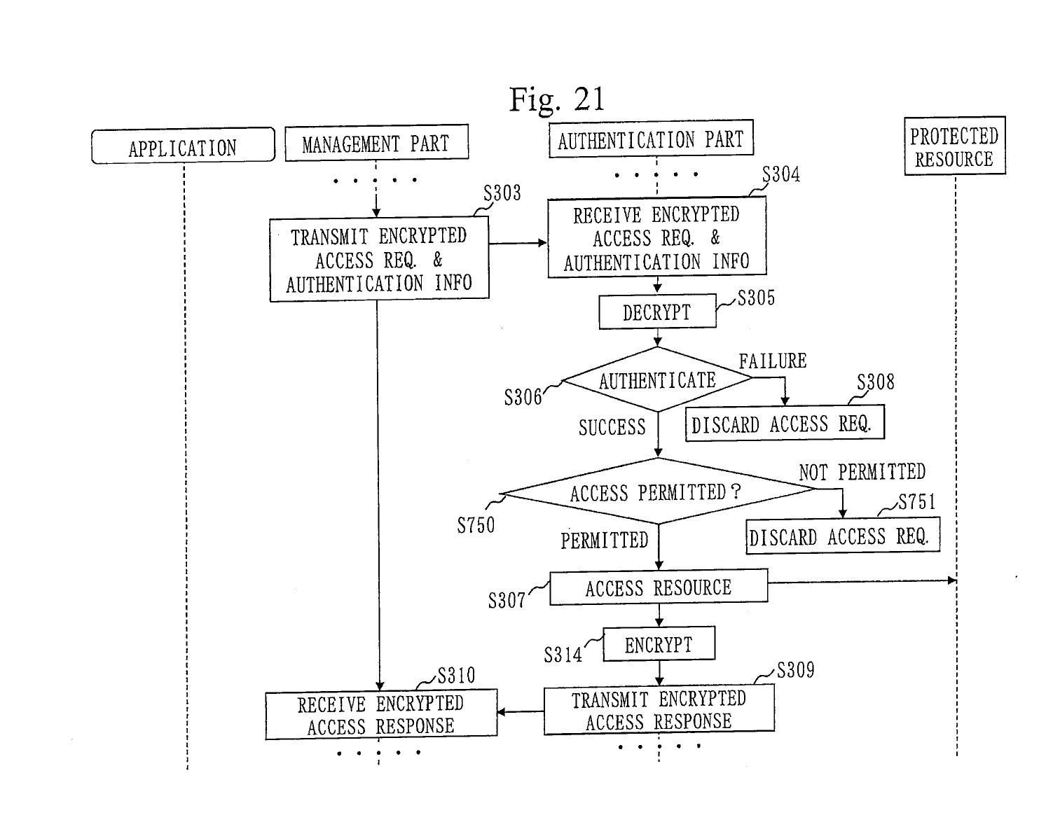

FIG. 21 shows a process flow of the application program execution device 1 according to this embodiment.

FIG. 21 shows part of the process flow. A process flow of transmitting the access request from the application 5 to the application management part 21 and transmitting the access response from the application management part 21 to the application 5 is the same as that in FIGS. 8 and 9, and its description will accordingly be omitted.

The application management part is expressed as “management part”.

Communication from the application 5 to the application management part 21 is permitted only where, for example, the digital certificate used when installing the application 5 is the same as the digital certificate used when installing the application management part 21.

Namely, the communication between the application 5a and the application management part 21a is permitted only where the digital certificates of the application 5a and application management part 21a are the same.

Likewise, the communication between the application 5b and the application management part 21b is permitted only where the digital certificates of the application 5b and application management part 21b are the same.

The second communication part 10 (not shown) of the application management part 21 transmits the encrypted access request and authentication information to the authentication part 7 (S303).

The access request includes the identification information of the resource of the access destination.

In the authentication part 7, the second communication part 11 receives the encrypted access request and authentication information from the application management part 21 (S304).

The encryption part 29 decrypts the encrypted authentication information and access request with the encryption key 28 (S305).

Furthermore, the authentication information verification part 14 verifies the authentication information using the authentication key 27, thereby authenticating whether or not the access request has been transmitted from a legitimate transmission source (that is, the application management part 21) (S306).

As the result of the authentication in S306, if the authentication is successful, the access control part 91 determines whether or not the requested access is a permitted access, based on the information that identifies the application management part 21, being the transmission source of the access request, and by the identification information of the resource of the access destination (S750).

As the information that identifies the application management part 21 being the transmission source of the access request, for example, the difference (for example, port number) between the transmission path from the application management part 21a to the authentication part 7 and the transmission path from the application management part 21b to the authentication part 7, predetermined application management part ID received from the application management part 21, key ID assigned to the encryption key and the authentication key, and the like can be used.

Alternatively, the authentication part 7 may hold, in the form of a list, the information that identifies the application management part 21 being the transmission source of the access request and the identification information of the resource of the access destination.

If the result of the determination indicates accessible, the authentication part 7 accesses the requested resource (S307).

If the result of the determination indicates non-accessible, the authentication part 7 discards the access request (S751).

At this time, the second communication part 11 may respond to the application management part 21 that the resource is non-accessible.

As the result of the authentication in S306, if the authentication fails, the authentication part 7 discards the access request (S308).

At this time, the second communication part 11 may respond to the application management part 21 that the resource is non-accessible.

After that, in the authentication part 7, the encryption part 29 encrypts the access response using the encryption key 28 (S308).

Then, the second communication part 11 transmits the encrypted access response to the application management part 21 (S309).

Where the access request is information reading or the like, the readout information may be included in this response.

In the application management part 21, the second communication part 10 receives the encrypted access response from the authentication part 7 (S310).

The application management part 21 need not be an application, but can be a service operating in the background and not having a user interface.

In this embodiment, the encryption key different from the authentication key is provided. Alternatively, the same key may be used as the authentication key and the encryption key.

In that case, the authentication information generation part 24 generates the authentication information and encrypts/decrypts the authentication information.

Also, the authentication key and the encryption key may be changed from one application management part 21 to another.

In that case, a key ID that uniquely identifies a corresponding key may be provided.

In this embodiment, the authentication part 7 authenticates the application management part 21. Alternatively, a process of authenticating the authentication part 7 by the application management part 21 may be added, and the application management part 21 and the authentication part 7 may authenticate each other.

This mutual authentication provides a more secure system to the user.

Also, the authentication part 7 may be provided outside the application program execution device 1, as with an IC card. The application management part 21 in the application program execution device 1 may access a resource in or outside the application program execution device 1 via the external authentication part 7.

The application management part 21 may be constituted by a single application management part, and the authentication part or the application management part 21 may determine the access using the ID of the application, or the identification information, acquired from the virtual execution environment, of the communication destination application of the application management part 21.

In this embodiment, the application 5 accesses the resource via the application management part 21. However, the resource can be accessed using the information obtained from the application management part 21, not via the application management part 21, as in Embodiments 5 and 6.

As described above, the application 5 accesses the resource via the application management part 21 and the authentication part 7. Hence, authentication information that should be kept secret need not be incorporated in the application 5, so that a secure system can be provided to the user.

An application developer does not need to conduct the security management of the authentication information, and authentication for a plurality of applications can be performed by the single application management part 21. Thus, the application development cost can decrease, so that the service can be provided to the user at a low cost.

Also, accesses to a plurality of resources by a plurality of applications can be controlled finely, so that a secure system can be provided to the user.

### Embodiment 9

The above embodiments have shown an example where the protected resource 2 is located inside the application program execution device 1.

The present embodiment shows an example where the authentication part 7 and the protected resource 2 are provided outside the application program execution device 1.

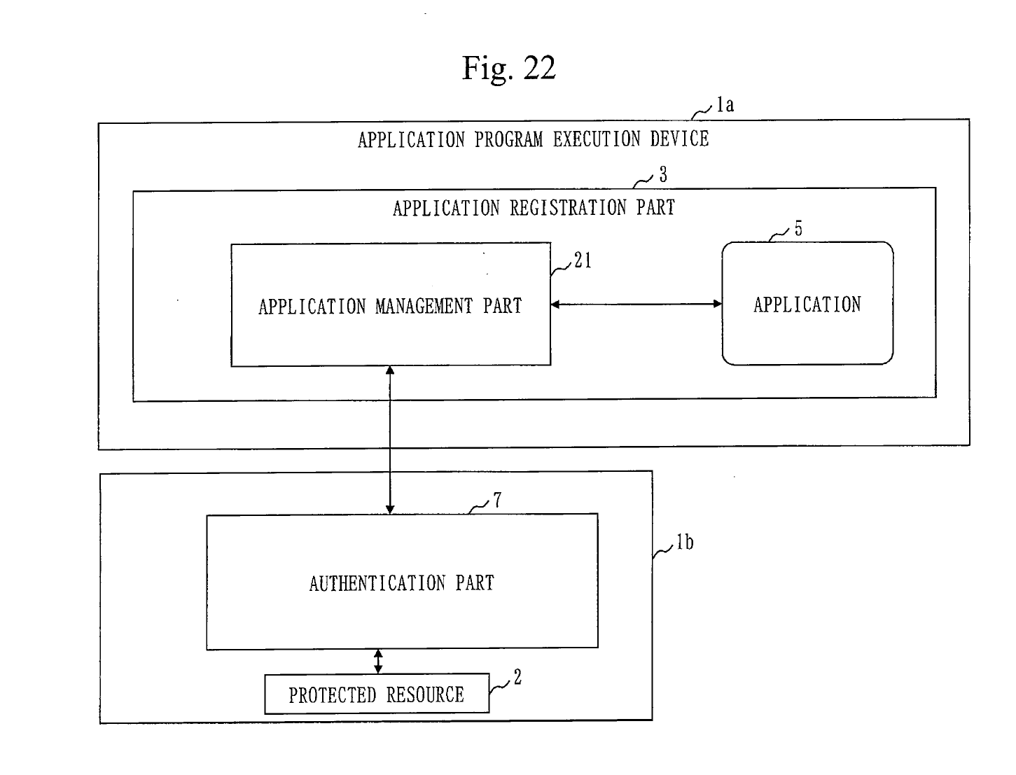

FIG. 22 is a configuration diagram of the application program execution device 1 according to this embodiment.

In this embodiment, the application 5 and the application management part 21 are provided to a first application program execution device 1a, and the function of the authentication part 7 and the resource are provided, as a second application program execution device 1b, outside the first application program execution device 1a.

The second application program execution device 1b is an example of an external device.

The second application program execution device 1b can be implemented by, for example, an IC card internally containing confidential information.

The elements of the first application program execution device 1a and the elements of the second application program execution device 1b are the same as those described previously, and a description thereof will accordingly be omitted.

The operation is the same as those in the process flow of FIGS. 8 and 9 described in Embodiment 3 except for the following respects, and its description will accordingly be omitted. In this embodiment, the operations of the application 5 and application management part 21 are executed by the first application program execution device 1b, and the operations of the resource 2 and the authentication part 7 are executed by the second application program execution device 1b. Except for these respects, the process flow of Embodiment 9 is the same as that of Embodiment 3.

As described above, even when the application program execution device 1 is separated into the first application program execution device and the second application program execution device, the same effect as those of the above embodiments can be obtained.

The respective embodiments of the present invention have been described. Of these embodiments, two or more embodiments may be combined and practiced.

Alternatively, of these embodiments, one embodiment may be practiced partially.

Alternatively, of these embodiments, two or more embodiments may be combined partially and practiced.

The present invention is not limited to these embodiments, and various changes can be made where necessary.

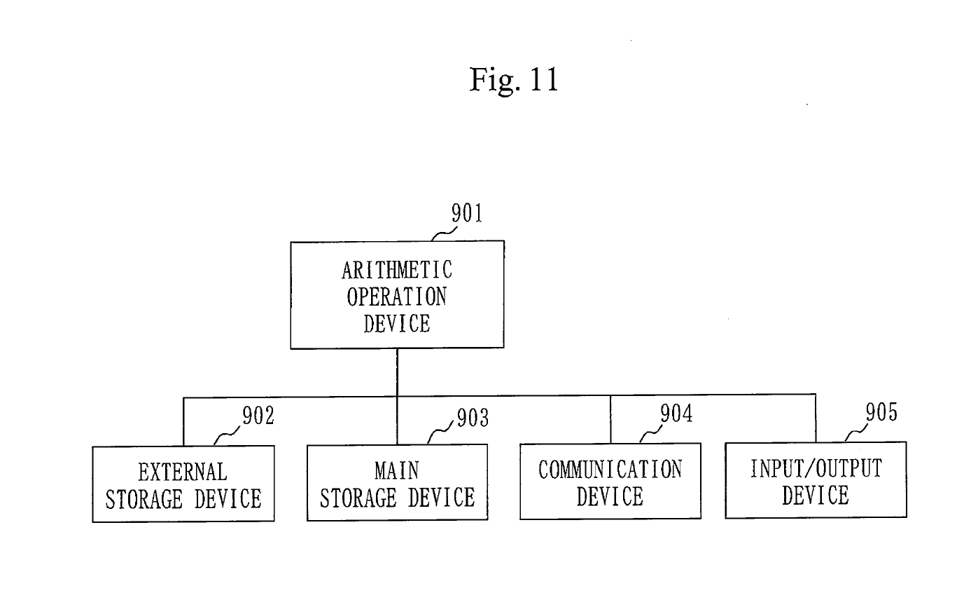

Finally, a hardware configuration example of the application program execution device 1 indicated in Embodiments 1 to 9 will be described with reference to FIG. 11.

The application program execution device 1 is a computer, and can implement the respective elements of the application program execution device 1 in the form of programs.

As the hardware configuration of the application program execution device 1, an arithmetic operation device 901, an external storage device 902, a main storage device 903, a communication device 904, and an input/output device 905 are connected to a bus.

The arithmetic operation device 901 is a CPU that executes the programs.

The external storage device 902 is, for example, a ROM, a flash memory, or a hard disk device.

The main storage device 903 is a RAM.

The communication device 904 is used when, for example, communicating with the authentication device 61 of Embodiment 4.

The communication device 904 may be connected to a network such as a LAN (Local Area Network).

The input/output device 905 is, for example, a mouse, a keyboard, or a display device.

The programs are usually stored in the external storage device 902. The programs as loaded in the main storage device 903 are sequentially read and executed by the arithmetic operation device 901.

Each program is a program that realizes a function described as “part” (except for “authentication key storage part 22”) in the application management part 6 or 21 shown in FIG. 1 or the like.

Furthermore, the external storage device 902 also stores an operating system (OS). At least part of the OS is loaded in the main storage device 903. The arithmetic operation device 901, while executing the OS, executes a program that realizes the function of the “part” show in FIG. 1 or the like.

The application 5 and the authentication part 7 are also stored in the external storage device 902 and, as loaded in the main storage device 903, are sequentially executed by the arithmetic operation device 901.

The authentication key and the encryption key are also stored in the external storage device 902 and, as loaded in the main storage device 903, are sequentially used by the arithmetic operation device 901.

The information, data, signal values, and variable values representing the result of the processes described in the explanations of Embodiments 1 to 9 as “determination”, “distinguishing”, “verification”, “authentication”, “acquisition”, “reading”, “extraction”, “detection”, “setting”, “registration”, “selection”, “generation”, “inputting”, “receiving”, and the like are stored, in the form of files, in the main storage device 903.

Random values, parameters, and digital certificates may be stored, in the form of files, in the main storage device 903.

At least part of the “part” of the application management part 6 or 21 shown in

FIG. 1 and the like may be realized as firmware.

The configuration of FIG. 11 merely shows an example of the hardware configuration of the application program execution device 1. The hardware configuration of the application program execution device 1 is not limited to the configuration indicated in FIG. 11, but can be another configuration.

### REFERENCE SIGNS LIST

1: application program execution device; 2: protected resource; 3: application registration part; 4: operation part; 5: application; 6: application management part; 7: authentication part; 8: first communication part; 9: first communication part; 10: second communication part; 11: second communication part; 12: authentication information storage part; 13: authentication information; 14: authentication information verification part; 15: authentication information; 16: authentication information acquisition part; 20: shared memory; 21: application management part; 22: authentication key storage part; 23: authentication key; 24: authentication information generation part; 25: encryption key; 26: encryption part; 27: authentication key; 28: encryption key; 29: encryption part; 30: transfer flag; 50: native application; 51: OS; 52: virtual execution environment; 60: third communication part; 61: authentication device; 62: third communication part; 70: first authentication information generation part; 71: second communication part; 72: first authentication information verification part; 73: second authentication information generation/verification part; 80: first authentication key; 81: second authentication information generation part; 82: first authentication key; 83: second authentication key generation part; 84: second authentication key; 85: second authentication information verification part; 90: validity determination part

1. An application program execution device in which an application program is implemented and which comprises an application program management part that manages use of a resource by the application program,
the application program management part having
a first communication part for communicating with the application program,
an authentication information acquisition part which acquires authentication information with which the application program management part is proven to be legitimate through a predetermined authentication process, independently of the application program, and
a second communication part which transmits the authentication information acquired by the authentication information acquisition part to an authentication part which determines whether or not the application program is permitted to use the resource.

2. The application program execution device according to claim 1,
wherein the authentication information acquisition part acquires authentication information that is kept confidential only to the authentication part.

3. The application program execution device according to claim 1,
wherein the first communication part receives a resource use request requesting use of a predetermined resource in the application program execution device, from the application program, and
wherein the second communication part transmits the resource use request received by the first communication part and the authentication information acquired by the authentication information acquisition part to the authentication part.

4. The application program execution device according to claim 3,
wherein the application program management part further has an authentication information storage part which stores authentication information with which the application program management part is proven to be legitimate, the authentication information being shared with the authentication part,
wherein the authentication information acquisition part reads the authentication information from the authentication information storage part, and
wherein the second communication part transmits the resource use request received by the first communication part and the authentication information read by the authentication information acquisition part from the authentication information storage part, to the authentication part.

5. The application program execution device according to claim 3,
wherein the application program management part further has an authentication key storage part which stores an authentication key shared with the authentication part,
wherein the authentication information acquisition part, using the authentication key stored in the authentication key storage part, generates authentication information with which the application program management part is proven to be legitimate, and
wherein the second communication part transmits the resource use request received by the first communication part and the authentication information generated by the authentication information acquisition part, to the authentication part.

6. The application program execution device according to claim 3, further comprising a shared memory used for communication with the authentication part,
wherein the second communication part writes the resource use request and the authentication information into the shared memory.

7. The application program execution device according to claim 1,
wherein the authentication information acquisition part acquires authentication information with which the application program management part is proven to be legitimate through a predetermined authentication process, as first authentication information, independently of the application program, and
wherein the second communication part transmits the first authentication information acquired by the authentication information acquisition part to the authentication part, and when the application program management part is proven to be legitimate with the first authentication information in the authentication part, receives either one of second authentication information and a second authentication key from the authentication part, the second authentication information being used by the authentication part when determining whether or not the application program is permitted to use the resource, the second authentication key being an authentication key used for generating the second authentication information.

8. The application program execution device according to claim 7,
wherein the first communication part, when the second authentication information is received by the second communication part, transmits the second authentication information to the application program, and causes the application program to transmit the second authentication information together with a resource use request requesting use of a resource, to the authentication part.

9. The application program execution device according to claim 7,
wherein the application program management part further has a second authentication information generation part which, when the second authentication key is received by the second communication part, generates the second authentication information using the second authentication key, and
wherein the first communication part transmits the second authentication information generated by the second authentication information generation part to the application program, and causes the application program to transmit the second authentication information together with a resource use request requesting use of a resource, to the authentication part.

10. The application program execution device according to claim 8,
wherein the first communication part causes the application program to transmit the second authentication information to the authentication part which determines a validity of the second authentication information.

11. The application program execution device according to claim 1, wherein the application program management part and the application program operate in a virtual execution environment built in the application program execution device.

12. The application program execution device according to claim 3,
wherein the authentication part is disposed in the application program execution device, and
wherein the second communication part transmits the resource use request and the authentication information to the authentication part in the application program execution device.

13. The application program execution device according to claim 3,
wherein the authentication part is disposed in an external device other than the application program execution device, and
wherein the second communication part transmits the resource use request and the authentication information to the authentication part in the external device.

14. The application program execution device according to claim 7,
wherein the authentication part is disposed in the application program execution device, and
wherein the second communication part transmits the first authentication information to the authentication part in the application program execution device.

15. The application program execution device according to claim 7,
wherein the authentication part is disposed in an external device other than the application program execution device, and
wherein the second communication part transmits the first authentication information to the authentication part in the external device.

16. The application program execution device according to claim 1,
wherein two or more application programs are implemented in the application program execution device,
wherein the application program execution device has two or more application program management parts, and
wherein each of the application program management parts corresponds to any one of the two or more application programs, and manages use of the resource by the corresponding application program.
